(19) United States
(12) Patent Application Publication
(10) Pub. No.: US 2008/0236627 A1
(43) Pub. Date: Oct. 2, 2008

(54) METHOD FOR CLEANING WEB-LIKE OBJECT TO BE CLEANED AND APPARATUS USING THE SAME

(75) Inventors: Hideaki Kominami, Odawara-shi (JP); Kazuhiro Muramasu, Odawara-shi (JP); Manabu Oohira, Odawara-shi (JP); Norikazu Oota, Shizuoka (JP)

Correspondence Address: SUGHRUE MION, PLLC, 2100 PENNSYLVANIA AVENUE, N.W., SUITE 800, WASHINGTON, DC, 20037, US

(73) Assignees: FUJIFILM Corporation, Tokyo (JP); FUJIFILM Opto Materials Corporation, Shizuoka (JP)

(21) Appl. No.: 12/058,725

(22) Filed: Mar. 30, 2008

(30) Foreign Application Priority Data
Mar. 30, 2007 (JP) 2007-095553

(51) Int. Cl. B08B 7/04; B08B 13/00; B08B 3/08

(52) U.S. Cl. 134/18; 134/30; 134/95.3; 134/56 R

(57) ABSTRACT

A method for cleaning a web-like object to be cleaned, comprising the steps of:
a cleaning solution spraying step for spraying a cleaning solution to a surface of a fed web-like object to be cleaned; and
a cleaning solution removing step for removing the liquid film left on the surface of the object to be cleaned by ejecting a gas so that at least an ejected gas flow is formed in a direction opposite to the feeding direction of the object to be cleaned, wherein
among the air induced by the gas ejection, the air induced from the side of the cleaning solution spraying position to the side of the gas ejection position is shielded.

### BACKGROUND OF THE INVENTION

1. Field of the Invention

The present invention relates to a method for cleaning a web-like object to be cleaned and an apparatus using the same, and specifically, relates to a cleaning technology for removing an alkaline fluid which is once coated to a polymer film used as a transparent support of an elongated optical compensatory sheet for alkaline saponification.

2. Description of the Related Art

In recent years, the demands for optical films have been increasing. An example of the optical films is an optical compensatory sheet which is used as a wave plate in a liquid crystal cell.

In manufacturing an optical compensatory sheet which includes a transparent support of a polymer film and an optical anisotropic layer of an oriented film and liquid crystalline molecules fixed on the transparent support, a strong adherence between a transparent support (usually, a cellulose ester film such as a cellulose acetate film) and the oriented film (usually, polyvinyl alcohol) is required. As a cellulose ester film has a low affinity to polyvinyl alcohol, and peelings and cracks occur at the interface between the cellulose ester film and polyvinyl alcohol, a gelatin subbing layer is provided on the cellulose acetate film. However, as a coating solution solvent in coating of the gelatin subbing layer, in order to obtain a strong adherence between the subbing layer and the cellulose ester film, a solvent which permeates the cellulose ester film (for example, a ketone based solvent) has to be used, the cellulose ester film swells, which causes a problem that the film slightly bends when the film shrinks in a following drying step. It has been found that when an oriented film and then a layer of liquid crystalline molecules are coated on the bent film serially, an uneven thickness of the oriented film and the liquid crystalline molecules layer along the bent shape, and an uneven orientation of the liquid crystalline molecules are generated, and the image quality of a liquid crystal display apparatus using the film is degraded.

As a general method for improving the adherence between a cellulose ester film and a hydrophilic material (for example, an oriented film) without providing a gelatin subbing layer, a method using a so-called saponification bath process is known in which a film is immersed in an alkali aqueous solution (for example, see Japanese Patent Application Laid-Open No. 8-94838). However, in the saponification bath process which involves an immersion, because both surfaces of a cellulose ester film are simultaneously hydrophilizd, when the film is wound up in a roll after a hydrophilic layer of polyvinyl alcohol for example is coated on one of the surfaces, a problem of adherence between the front surface and the back surface occurs. In the saponification bath process, for hydrophilizing only one surface of a film, a method of waterproofing a surface which is not to be used by laminating may be used, but this increased a complicated step, and also increased unnecessary wastes, which is not preferable in terms of productivity and environmental preservation.

In such context, a saponification method has been proposed in which an alkaline solution is continuously coated on one surface of a polymer film to which an oriented film is coated, and after a certain reaction time passes, the alkaline solution is washed off from the polymer film by a cleaning solution (for example, see Japanese Patent Application Laid-Open No. 2003-313326).

In the above method for hydrophilizing a polymer film by alkaline saponification, during the alkaline fluid coated to the polymer film is being washed off, the saponification reaction is still taking place, thereby if the film is not uniformly washed, uneven saponification is generated, which renders the film defective. Specifically, there is a method for removing a liquid film which is formed by spraying a cleaning solution to a polymer film, by spraying a gas, but in the method, any reattachment of the removed droplets or mists scattered by the gas spray to the polymer film makes the cleaning of the film ununiform. In addition, if the droplets or mists are attached to an ejection port of a gas ejecting device, the ejection port may be clogged with scales in the droplets. Therefore, a uniform removal of a cleaning solution from a polymer film, as well as a prevention of droplets and mists of the removed cleaning solution from reattachment are the key factors for a uniform cleaning.

A technology of removing a liquid attached to a surface of a sheet-like object by spraying a gas is disclosed in Japanese Patent Application Laid-Open No. 6-99150, which proposes a method in which a liquid attached to a web-like sheet is blown off by air and the blown liquid is sucked by a sucking apparatus. Japanese Patent Application Laid-Open No. 2003-229404 proposes a method in which any reattachment of mists to a substrate is prevented by sucking the mists scattered from a sheet-like substrate to be treated by a sucking apparatus in a drying process of spraying a gas to the substrate. Moreover, Japanese Patent Application Laid-Open No. 2001-224993 proposes a method in which when a treatment solution attached to a plate-shaped substrate is blown off and dried, in order to prevent a complete drying, a treatment solution of the same kind as that of the attached solution is atomized and sprayed to the surface of the substrate where the treatment solution was attached.

However, as disclosed in Japanese Patent Application Laid-Open Nos. 6-99150 and 2003-229404, the methods for sucking a removed liquid by a sucking apparatus requires the separate sucking apparatus, results in a disadvantage of an increased size of the entire apparatus. Since the technology of Patent Application Laid-Open No. 6-99150 was developed to leave no droplets on a sheet after the sheet passes an ejection nozzle, that is, after a liquid is removed, in a case of an agent cleaning where a chemical reaction of the agent is taking place during a cleaning as in a preferred example to which the present invention is applied, any reattachment of droplets and mists during a cleaning, that is before the film passes a gas ejection nozzle, cause uneven progress of a chemical reaction. Furthermore, Japanese Patent Application Laid-Open Nos. 2003-229404 and 2001-22499 propose a technology for removing a liquid from plate-shaped substrates which are discontinuously fed by an ejection of a gas, and reattachment of droplets and mists are prevented only when the substrates pass. Thus, the above technology can be applied to treat plate-shaped substrates which are discontinuously fed, but causes a problem of reattachment of droplets and mists in a case where a web-like object to be cleaned is continuously fed as in the present invention.

A technology of uniform cleaning is required in coating an agent to a web-like object to be cleaned for a chemical reaction and then cleaning and removing the agent to stop the chemical reaction, not only for saponification of a polyethylene film to manufacture an optical compensatory sheet but also in other fields.

### SUMMARY OF THE INVENTION

The present invention has been made in view of the above situation, and one object of the present invention is to provide a method for cleaning a web-like object to be cleaned and an apparatus using the same in which when a liquid film formed by spraying a cleaning solution to web-like object to be cleaned is removed by ejecting a gas from an ejection nozzle, any reattachment of droplets and mists of the removed cleaning solution can be prevented, so that a uniform cleaning can be achieved without unevenness and an ejection port of the ejection nozzle is not clogged with the droplets and scales of mists even in a case of an agent cleaning where a chemical reaction is taking place during the cleaning.

In order to achieve the above object, a first aspect of the present invention is a method for cleaning a web-like object to be cleaned which includes: a cleaning solution spraying step for spraying a cleaning solution to a surface of a fed web-like object to be cleaned; and a cleaning solution removing step for removing the liquid film left on the surface of the object to be cleaned by ejecting a gas so that at least an ejected gas flow is formed in a direction opposite to the feeding direction of the object to be cleaned, wherein among the air induced by the gas ejection, the air induced from the side of the cleaning solution spraying position to the side of the gas ejection position is shielded.

The droplets removed from an object to be cleaned include mists, and the feeding direction of an object to be cleaned is preferably a horizontal direction, but may be slightly inclined relative to the horizontal direction. The same shall be applied to the following description.

The inventors of the present invention obtained an actual knowledge that an induced air which is induced by a gas ejection is significantly involved in the factor of the reattachment of droplets of a cleaning solution removed from an object to be cleaned to the object to be cleaned and an ejection nozzle. That is, an ejector action by the gas ejection induces the air around the ejection, which causes an induced air from the cleaning solution spraying position toward the gas ejection position as an induced air flow. Then, the droplets of the cleaning solution removed from an object to be cleaned are carried by the induce air to be reattached to a surface of the object to be cleaned which is still being cleaned and an ejection nozzle from which the gas is ejected. The droplets reattached to the object to be cleaned cause unevenness in the cleaning, and also the droplets reattached to an ejection port of the ejection nozzle cause a clogging of the ejection port with the scales in the droplets (solid content of the droplets).

According to the first aspect of the present invention, among the induced air elements which are induced by the gas ejection, the induced air element from the side of the spraying position to the side of the ejection position is at least shielded, thereby any reattachment of the droplets of the cleaning solution removed from the object to be cleaned to a surface of the object to be cleaned and the ejection nozzle can be prevented. Therefore, even in a case of an agent cleaning where a chemical reaction is taking place during the cleaning, a uniform cleaning can be achieved without unevenness, and therefore no un-uniform chemical reaction takes place on the entire object to be cleaned. Moreover, no scales in the attached droplets cause a clogging of the ejection port of the ejection nozzle.

A second aspect of the present invention according to the first aspect is that the surface of the object to be cleaned is coated with an agent for a chemical reaction with respect to the object to be cleaned, and is cleaned with the cleaning solution in order to stop the chemical reaction of the agent.

The present invention is especially effective in a case where an agent is coated for a chemical reaction with respect to an object to be cleaned and the object is cleaned with a cleaning solution to stop the chemical reaction of the agent as in the second aspect. Herein, the stop of the chemical reaction by cleaning is not simply limited to the washing off of an agent for a chemical reaction, but also includes the stop of the chemical reaction of the agent by carrying out a chemical reaction between the agent an the cleaning solution.

A third aspect of the present invention according to the second aspect is that the object to be cleaned is a polymer film, and the agent is an alkaline fluid for alkaline saponification process of the polymer film.

The present invention is especially effective in a case where an optical compensatory film is manufactured, because a uniform cleaning with good accuracy is required in a step of the manufacturing for carrying out an alkaline saponification of a polymer film as a transparent support and cleaning an alkaline fluid with a cleaning solution to stop the saponification reaction as in the third aspect.

A fourth aspect of the present invention according to any one of the first to third aspects is the method for cleaning a web-like object to be cleaned which further includes: a step for detecting an outer edge of an ejected gas flow which is formed in a direction opposite to the feeding direction of the object to be cleaned, and a step for arranging a tip of a windshield wall which shields the induced air at the outer edge based on the detected result.

The fourth aspect defines a preferred arrangement position of a windshield wall.

The present invention is more effective in preventing any reattachment of the droplets removed from an object to be cleaned to a surface of the object to be cleaned and an ejection nozzle because an induced air which is induced from a spraying position to an ejecting position is shielded by a windshield wall, as compared to the case without the windshield wall, but is further more effective when a windshield wall is arranged at an appropriate position. Herein, a windshield wall is not limited to a solid object, but includes a wall formed of a gas such as an air curtain. The windshield wall has a width which is preferably equal to or 1.3 times that of an object to be cleaned, and is preferably formed to have a thickness of 0.1 to 10 mm.

According to the fourth aspect of the present invention, since a tip of a windshield wall (the tip of the windshield wall toward an object to be cleaned) is arranged at the outer edge of an ejected gas flow, the arrangement of the windshield wall does not reduce the removal performance for removing a cleaning solution from the object to be cleaned, and also improves the effect to prevent reattachment of the removed droplets to a surface of the object to be cleaned and the ejection nozzle.

The term “outer edge” as used herein means an immediately outer area to an area where an ejected flow of a gas is formed in a flared shape from an ejection position, and has a wind speed of substantially zero. Specifically, the outer edge is an area having a wind speed of from 0 m/sec up to a smaller value either of a value of 0.5% or less of an ejection speed of a gas from the nozzle or 0.5 m/sec. Therefore, the outer edge can be specified by measuring a wind speed at several points near an ejected gas flow.

A fifth aspect of the present invention according to any one of the first to fourth aspects is that the cleaning solution spraying step and the cleaning solution removing step are carried out as a set of cleaning steps at multiple stages, and at each cleaning step, a wet processing is implemented so that the object to be cleaned is fed with the surface of the object to be cleaned being maintained in a uniformly wetted state to a cleaning step at a next stage.

The fifth aspect of the present invention is based on the premise that a cleaning solution spraying step and a cleaning solution removing step are carried out as a set of cleaning steps at multiple stages. For example, in a case where the cleaning steps are carried out at three stages, if a surface of an object to be cleaned is too dry because a cleaning solution is generally completely removed from the object to be cleaned at a first stage of cleaning steps, a sprayed cleaning solution is unlikely to be uniformly coated to the subject of the object to be cleaned at a second stage of the cleaning steps. This causes uneven thickness of a resulting liquid film, resulting in an uneven cleaning. The uneven cleaning leads to an uneven chemical reaction in a case of an agent cleaning where a chemical reaction of the agent is taking place even during a cleaning, which renders the object defective.

In the fifth aspect of the present invention, a surface of an object to be cleaned is fed with maintaining a uniformly wetted state to a cleaning step to a next stage, thereby a cleaning solution can be sprayed to the object to be cleaned to obtain a uniform coating without generating an uneven thickness of the liquid film, which unlikely causes uneven cleaning.

A sixth aspect of the present invention according to the fifth aspect is that, the wet processing comprises a step of controlling of a flow rate and/or amount of the ejected gas flow.

The sixth aspect of the present invention shows a preferred aspect of a wet processing, and is a method for controlling a flow rate and/or amount of an ejected gas flow. An amount of a cleaning solution which is removed from an object to be cleaned is changed depending on a control of a flow rate and/or amount of an ejected gas flow, thereby a flow rate and/or amount can be controlled to maintain a wetted state of a surface of the object.

A seventh aspect of the present invention according to the fifth aspect is that, the wet processing comprises a step of entraining of the vapor of the cleaning solution in the gas which forms the ejected gas flow.

The seventh aspect of the present invention shows another preferred aspect of a wet processing, and is a method for entraining the vapor of the cleaning solution into the gas of the ejected gas flow. In this aspect also, the control of a flow rate and/or amount of an ejected gas flow may be implemented.

An eighth aspect of the present invention according to the fifth aspect is that, the wet processing comprises a step of ejecting of a humidifying gas to humidify the surface of the object to be cleaned as well as an ejected gas flow which removes the cleaning solution from the surface of the object to be cleaned.

The eighth aspect of the present invention shows further another preferred aspect of a wet processing, and is a method for ejecting a humidifying gas to humidify a surface of the object to be cleaned separately from an ejected gas flow which removes a cleaning solution. In this aspect also, the control of a flow rate and/or amount of an ejected gas flow may be implemented.

A ninth aspect of the present invention according to any one of the first to eighth aspects is that the surface to be cleaned of the fed object to be cleaned is the lower surface of upper and lower surfaces of the object to be cleaned.

When the surface of an object to be cleaned, that is a surface to be cleaned, is a lower surface thereof, it is more preferable because the droplets of a cleaning solution removed from the object to be cleaned naturally drop down.

In order to achieve the above object, a tenth aspect according to the present invention provides an apparatus for cleaning a web-like object to be cleaned including: a cleaning solution spray nozzle which sprays a cleaning solution to a surface of a fed web-like object to be cleaned; and a gas ejection nozzle which ejects a gas so as to form at least an ejected gas flow in a direction opposite to the feeding direction of the object to be cleaned to remove the liquid film left on the surface of the object to be cleaned, wherein a windshield wall is interposed between the cleaning solution spray nozzle and the gas ejection nozzle in a direction which is orthogonal to the feeding direction of the object to be cleaned.

The tenth aspect of the present invention is configured as an apparatus which includes a windshield wall between a cleaning solution spray nozzle and a gas ejection nozzle in a direction which is orthogonal to the feeding direction of an object to be cleaned, so that the induced air which is induced from the spray position side to the ejection position side can be shielded. The windshield wall has a width which is preferably equal to or 1.3 times that of an object to be cleaned, and is preferably formed to have a thickness of 0.1 to 10 mm.

An eleventh aspect of the present invention according to the tenth aspect is that the windshield wall shields the air induced from the side of the cleaning solution spraying position to the side of the gas ejection position among the air which is induced by the gas ejection.

The eleventh aspect of the present invention enables a prevention of droplets of a cleaning solution removed from an object to be cleaned from being carried by the induced air and reattached to a surface of the object to be cleaned which is still being cleaned and a gas ejection nozzle because a windshield wall shields the air induced from the spraying position side to the ejection position side.

A twelfth aspect of the present invention according to the tenth or eleventh aspect is that the windshield wall is a plate shaped windshield.

The twelfth aspect shows a preferred aspect of a windshield wall which is a plate shaped windshield.

A thirteenth aspect of the present invention according to the tenth or eleventh aspect is that the windshield wall is an air curtain.

The thirteenth aspect shows another preferred aspect of a windshield wall which is an air curtain.

A fourteenth aspect of the present invention according to the tenth aspect or the eleventh aspect is that the windshield wall is a windshield box formed of porous plates, and the windshield box blows out a weak air stream.

The fourteenth aspect shows further another preferred aspect of a windshield wall which is a windshield box formed of porous plates, so that a weak air stream is blown out from the windshield box. The weak air stream blown out from the windshield box clears the droplets attached to the windshield box. In this case, since the droplets attached to the windshield box are scattered again to be attached to an object to be cleaned if an air stream is strongly blown out, the windshield box should blows out a weak air stream which is still enough to separate the droplets attached to the windshield box from the windshield box.

A fifteenth aspect according to at least one of the tenth to fourteenth aspects of the present invention provides the apparatus for cleaning a web-like object to be cleaned in which a surface of the object to be cleaned is coated with an agent for a chemical reaction with respect to the object to be cleaned, and the agent is cleaned with the cleaning solution in order to stop the chemical reaction of the agent.

A sixteenth aspect of the present invention according to the fifteenth aspect is that the object to be cleaned is a polymer film, and the agent is an alkaline fluid for alkaline saponification process of the polymer film.

A seventeenth aspect of the present invention according to any one of the tenth to sixteenth aspects is the apparatus for cleaning a web-like object to be cleaned further comprising a position control device which controls an arrangement position of the windshield wall.

According to the seventeenth aspect, a position control device provided for controlling an arrangement position of the windshield wall allows a windshield wall to be moved to an appropriate position for removing a cleaning solution and preventing any reattachment of the solution.

In this case, preferably a windshield wall is moved both horizontally (in a direction closer to and away from a gas ejection nozzle) and vertically (in a direction closer to and away from an object to be cleaned) to control its arrangement position.

An eighteenth aspect of the present invention according to the seventeenth aspect is the apparatus for cleaning a web-like object to be cleaned further comprising a detecting device which detects an outer edge of an ejected gas flow which is formed in a direction opposite to the feeding direction of the object to be cleaned, so that a tip of the windshield wall is arranged at the outer edge based on the detection result by the position control device.

The eighteenth aspect defines a preferred arrangement position of a windshield wall for removing a cleaning solution and preventing any reattachment of the solution, and a tip of a windshield wall is preferably arranged at the outer edge of an ejected gas flow. The outer edge is as described above.

A nineteenth aspect of the present invention according to any one of the tenth to eighteenth aspects is that the cleaning solution ejection nozzle and the gas ejection nozzle are provided as a set of cleaning unit at multiple stages, and each cleaning unit is provided with a wetting device which feeds the object to be cleaned with the surface of the object to be cleaned being maintained in a uniformly wetted state to a cleaning unit of a next stage.

The nineteenth aspect is an invention which is based on the premise that a cleaning solution spraying nozzle and a gas ejection nozzle are provided as a set of cleaning unit at multiple stages, and since each cleaning unit is provided with a wetting device which feeds the object to be cleaned with a surface of an object to be cleaned maintained in a uniformly wetted state to a cleaning unit of a next stage, an uneven coating of the cleaning solution can be prevented, which leads to a uniform cleaning.

Twentieth to twenty-second aspects of the present invention show preferred wetting devices: the twentieth aspect provides a device which controls a flow rate and/or amount of an ejected gas flow; the twenty-first aspect provides a device which entrains vapor (includes mists) of a cleaning solution into the gas ejected from an ejection nozzle; and the twenty-second aspect provides a humidifying device which humidifies a surface of an object to be cleaned.

A twenty-third aspect of the present invention is the apparatus for cleaning a web-like object to be cleaned in which the surface to be cleaned of an object to be cleaned is a lower surface of the object.

According to a method for cleaning a web-like object to be cleaned and an apparatus using the same of the present invention, when a liquid film which is formed by spraying a cleaning solution to web-like object to be cleaned is removed by a gas ejected from an ejection nozzle, any reattachment of droplets and mists of the removed cleaning solution to the object to be cleaned can be prevented.

Therefore, even in a case of an agent cleaning where a chemical reaction is taking place even during a cleaning, a uniform cleaning can be achieved without uneven cleaning, and also an ejection port of the ejection nozzle is not clogged with droplets and scales of mists.

### BRIEF DESCRIPTION OF THE DRAWINGS

FIG. 1 is an overall configuration diagram showing an alkaline saponification process line in which a cleaning apparatus according to the present invention is incorporated;

FIG. 2 is a conceptual diagram showing a cleaning apparatus according to the present invention;

FIG. 3 is a diagram illustrating an angle of an arrangement angle of a gas ejection nozzle;

FIG. 4 is a diagram illustrating a windshield wall of an air curtain type;

FIG. 5 is a diagram illustrating a windshield wall of a windshield box formed of a porous material;

FIG. 6 is a diagram illustrating a distance S between a tip of a windshield wall and a gas ejection nozzle, and a clearance T between the tip of the windshield wall and a web;

FIG. 7 is a graph showing a relationship between the distance S and the clearance T of FIG. 6 and a liquid film removing performance and a droplet attachment preventing performance, with a feeding speed of a web being 80 m/min;

FIG. 8 is a graph showing a relationship between the distance S and the clearance T of FIG. 6 and a liquid film removing performance and a droplet attachment preventing performance, with a feeding speed of a web being 100 ml/min;

FIG. 9 is a diagram illustrating a case where a tip of a windshield wall is at an appropriate arrangement position;

FIG. 10 is a diagram illustrating a case where a tip of a windshield wall is not at an appropriate arrangement position;

FIG. 11 is a diagram illustrating a case where a tip of a windshield wall is not at an appropriate arrangement position;

FIG. 12 is a diagram illustrating a case where a tip of a windshield wall is not at an appropriate arrangement position;

FIG. 13 is a diagram illustrating a case where a tip of a windshield wall is not at an appropriate arrangement position;

FIG. 14 is a conceptual diagram illustrating a multi-stage cleaning apparatus according to the present invention;

FIGS. 15A and 15B are conceptual diagrams showing a difference by the presence or the absence of a windshield wall of Example 1;

FIG. 16 is a table showing the effect of a uniform wetting processing in a multi-stage cleaning apparatus according to the present invention; and

FIGS. 17A and 17B are diagrams showing a case where a uniform wetted state cannot be formed on a web surface at a first stage of a multi-stage cleaning apparatus:

FIG. 17A shows a case where a web surface is too dry; and FIG. 17B shows a case where a web surface is too wet.

### DETAILED DESCRIPTION OF THE PREFERRED EMBODIMENTS

Now, preferred embodiments of a method for cleaning a web-like object to be cleaned and an apparatus using the same according to the present invention will be explained in detail below with reference to the accompanying drawings.

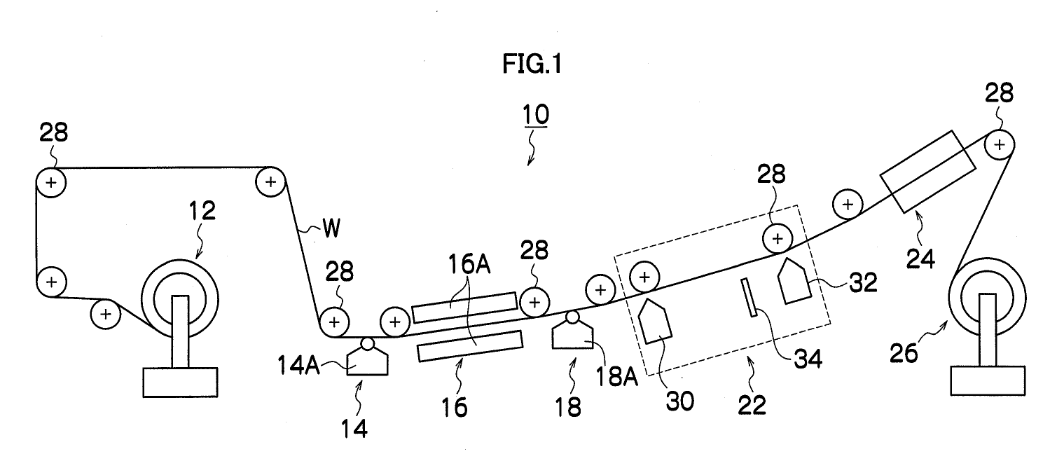

FIG. 1 is a configuration diagram showing an example in which a apparatus for cleaning a web-like object to be cleaned according to the present invention is incorporated in a line 10 for an alkaline saponification process of a polymer film. However, the present invention is not limited to the incorporation into the line 10 for an alkaline saponification process of a polymer film, and may be preferably applied to each field in which a uniform cleaning is required when an agent is coated to a web-like object to be cleaned for a chemical reaction and then the agent is removed by cleaning with a cleaning solution to stop the chemical reaction.

As shown in FIG. 1, the alkaline saponification process line 10 generally includes a supplying gas ejection nozzle 32, an alkaline solution coating apparatus 14 for coating an alkaline solution to a polymer film (hereinafter, referred to as a web W), a temperature maintaining apparatus 16 for maintaining a temperature of the web W which is a coating of the alkaline solution at a room temperature or more, a reaction stopping apparatus 18 for stopping the reaction by coating a dilution solvent or an acid solution to the web W at a maintained temperature, a cleaning apparatus 22 of the present invention for washing of the alkaline solution from the web W, a drying apparatus 24 for drying the cleaned web W, and a winder 26.

The alkaline solution coating apparatus 14 includes a coating device 14A which applies an alkaline solution to a lower surface of the web W supplied from a feeder 12 and guided by a guide roller 28. The web W and an alkaline fluid used in the present embodiment will be explained in detail later.

The coating device 14A may be preferably a die coater (extrusion coater, slide coater), a roll coater (forward roll coater, reverse roll coater, gravure coater), a rod coater (rod wound with a thin wire), and the like, but a rod coater, a gravure coater, a blade coater, a die coater are particularly preferable because of their stable operation for an area with a small amount of coating.

The coating amount of the alkaline solution is desirably reduced as much as possible in consideration of the disposal of a resulting wasted solution after water washing, and is preferably 1 to 100 cc/m², and more preferably 1 to 50 cc/m². A variation of a coating amount of the alkaline solution is preferably restricted to less than 30% relative to a transverse direction of the web W and a coating time.

In determining an coating amount of an alkali which is necessary for an alkaline saponification reaction, a total number of saponification sites (a theoretical coating amount of an alkali) which is obtained by multiplying the number of saponification reaction sites per a unit surface area of the web W by a saponification depth required for intimate adherence with an oriented film can be used as a rough guide. As a saponification reaction proceeds, the alkali is consumed, and a reaction speed becomes slower, thereby actually a several times of the theoretical coating amount of an alkali is preferably coated. Specifically, preferably two to twenty times, more preferably two to five times of the theoretical coating amount of an alkali is coated.

The alkaline solution desirably has a temperature equal to a reaction temperature (=a temperature of the web W). For a safe coating, the alkaline solution preferably has a temperature below its boiling point, more preferably below its boiling point by 5 degrees C., and most preferably below its boiling point by 10 degrees C.

The temperature maintaining apparatus 16 includes a heating device 16A which maintains a temperature of the web W at a room temperature (about 15 degrees C.) or more until a saponification reaction is completed after the alkaline solution is coated. The heating device 16A may be an impact of hot air to a surface opposite to a coating, a heat transfer by a contact of a heat roll, a microwave induction heating, a radiant heating by an infrared heater, or the like. An infrared heater is preferred because it provides heat in a non-contact manner without an air stream, which minimizes the influence onto a surface for an alkaline solution coating. The infrared heater may be an electric, gas type, oil type, or steam type far infrared ceramic heater. Any commercially available infrared heaters (for example, those manufactured by Noritake Co., Ltd) also may be used. An oil or steam type infrared heater in which a heat transfer medium uses oil or steam is preferred in terms of explosion proof in an atmosphere in which an organic solvent is present.

The temperature of the web W is set at 15 degrees C. to 150 degrees C., preferably 25 degrees C. to 100 degrees C., and more preferably 30 degrees C. to 80 degrees C. The temperature of the web W may be the same as or different from the heated temperature before a coating of an alkaline solution. The temperature of the web W may be detected by any commercially available non-contact infrared thermometer, and in order to control the above listed temperature ranges, a feedback control to the heating device 16A may be implemented.

The above listed temperature ranges are maintained for a time of period after an alkaline solution is coated and washed off depending on a feeding speed which will be described below, but preferably for 1 second to 5 minutes, more preferably 2 to 100 seconds, and particularly preferably 3 to 50 seconds.

A feeding speed of the web W is determined by a combination of a composition of the alkaline solution and a coating manner. The feeding speed of the web W is generally preferably 10 to 500 m/min, and more preferably 20 to 300 m/min.

The web W is preferably subjected to a saponification process under an atmosphere having an oxygen concentration within a range of 0 to 18%. The oxygen concentration is more preferably within a range of 0 to 15%, and most preferably 0 to 10%. An application of a saponification solution (alkaline solution) in a low oxygen concentration atmosphere enables a control of properties of a surface of the web W, resulting in a surface having a highly intimate adherence. The gas components other than oxygen in the atmosphere preferably consist of inert gases (e.g., nitrogen, helium, and argon), particularly preferably nitrogen.

The reaction stopping apparatus 18 includes a bar coater 18A which applies a dilution solvent for decreasing an alkali concentration to stop a saponification reaction between the alkaline solution and the web W. The dilution solvent is applied in the same way as that of the alkaline solution.

The dilution solvent is a solvent which dissolves an alkaline agent in the alkaline solution, and is preferably water or a mixed solution of an organic solvent and water, and more preferably water. Alternatively, the organic solvent used in the alkaline saponification solution may be advantageously used. A mixture of two or more organic solvents may be used.

An application amount of the dilution solvent is determined depending on a concentration of the alkaline solution. When the bar coater 18A uses a flat bar, the flow in a coating bead is not homogenous, and so the alkaline solution and the dilution solvent are mixed up, and the mixture is applied again. Therefore, in this case, since it is difficult to specify a dilution rate based on an application amount of the dilution solvent, the alkali concentration after the application of the dilution solvent has to be measured. The application amount of the dilution solvent enables a dilution of the original alkali concentration at a ratio of 1:1.5 to 10, more preferably 1:2 to 5.

Other than the dilution solvent, an acid may be used to rapidly stop an alkaline saponification reaction. In this case, a strong acid is preferably used to neutralize the alkali with a small amount of the acid. Considering the easiness of water washing, an acid which produces a salt having a high solubility after the neutralization with an alkali should be preferably selected, and for example, chloride, nitric acid, sulfuric acid, phosphoric acid, chromic acid, methanesulfonic acid, and citrate are preferably used.

An application amount of the acid solvent is determined depending on a type of the alkali and a concentration of the alkaline solution, and the application amount of the acid solvent is determined so that the pH level of the coating after the application of the acid solvent turns to be 4 to 9, preferably 6 to 8.

The cleaning apparatus 22 has to completely and evenly clean and remove the alkaline solution left on a surface of the web W, for example in manufacturing an optical compensatory sheet, in order to prevent any influence of the alkaline solution onto the formation and orientation of liquid crystalline molecules of an oriented film and a liquid crystalline molecules layer which will be coated in the following steps. The cleaning apparatus 22 will be explained in detail later.

The drying apparatus 24 is an apparatus for drying the cleaning solution L which is finally left on the web W after an alkaline fluid is washed off by the cleaning apparatus 22, and heats and dries the web W to obtain a preferably water content before the web W is wound into a roll. Conversely, the drying apparatus 24 is able to control humidity using an air having a set degree of humidity. The drying apparatus 24 may be any known heating and drying device which has a high cleanliness and supplies a clean air that is heated by a heater or the like. The drying air preferably has a temperature of 30 to 200 degrees C., more preferably 40 to 150 degrees C., and particularly preferably 50 to 120 degrees C. When the cleaning solution L is sufficiently removed using a gas ejection nozzle 32 such as an air knife at a stage prior to the drying apparatus 24, the drying apparatus 24 may not be provided.

The web W after the alkaline saponification process as described above may be wound up by the winder 26 once, or may be coated with a function layer of an optical compensatory sheet serially following the above described saponification process step.

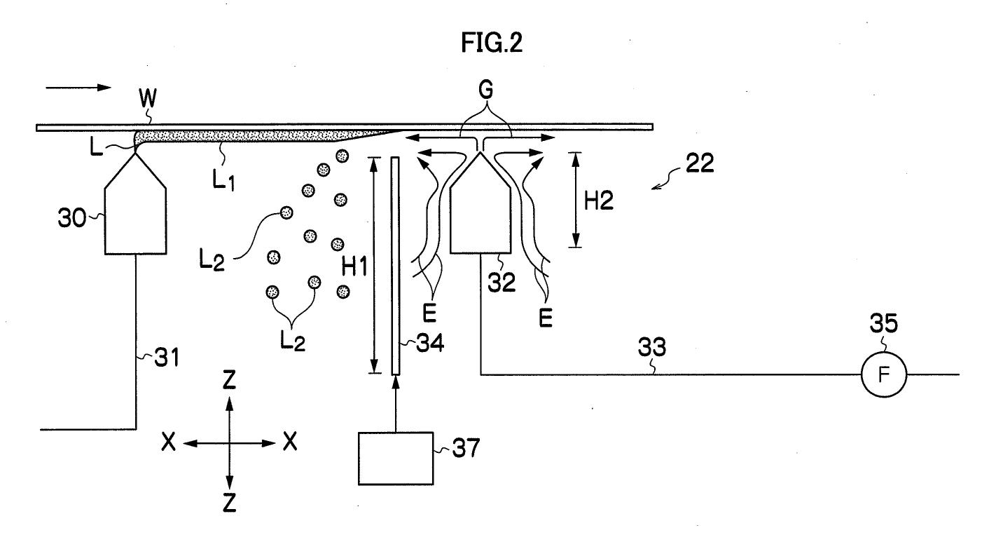

Next, a structure of the cleaning apparatus 22 according to the present invention will be explained in detail below. FIG. 2 is a conceptual diagram illustrating a structure of the cleaning apparatus 22.

As shown in FIG. 2, the cleaning apparatus 22 is generally configured with a cleaning solution spray nozzle 30 for spraying the cleaning solution L (generally, water is used) to a surface of a web, a gas ejection nozzle 32 for removing the liquid film L₁ left on the surface of the web W by ejecting a gas (generally, air is used) so that at least an ejected gas flow is formed in a direction opposite to the feeding direction of the web W, and a windshield wall 34 provided between the cleaning solution spray nozzle 30 and the gas ejection nozzle 32.

The cleaning solution spray nozzle 30 is connected with a cleaning solution supplying pipe 31, and the cleaning solution L which is force fed from the cleaning solution spray nozzle 30 is sprayed from the cleaning solution supplying pipe 31 to the lower surface of the web W. The cleaning solution spray nozzle 30 may be any commercially available spray nozzle (for example, those manufactured by Ikeuchi Co., Ltd., and those manufactured by Spraying Systems Co., Ltd.). This configuration allows a cleaning of the web W while the web W is continuously fed, and also forms a mixed turbulent flow with the cleaning solution L on the web W and an alkaline coating solution ejected by the ejection flow, which improves the cleaning effect. The cleaning solution spray nozzle 30 is not limited to the above example, and a coating head (e.g., a fountain coater and a frog mouth coater) may be used.

The cleaning solution spray nozzle 30 sprays the cleaning solution L at a speed, which causes a highly mixed turbulent flow and does not damage the feeding stability of the web W, of from preferably 50 to 1000 cm/sec, more preferably 100 to 700 cm/sec, further preferably 100 to 500.

The amount of the cleaning solution L used for a cleaning is greater than the theoretical dilution rate which is defined by the following formula:

Theoretical Dilution Rate=the amount of a used cleaning solution L [cc/m²]/the amount of a coated alkaline saponification solution [cc/m²] [Formula 1]

That is, a theoretical dilution rate is defined under an assumption that all of a cleaning solution L used in a cleaning contributes to the dilution and mixture of an alkaline coating solution. Actually, because the mixture is not perfect, an amount of a cleaning solution which is larger than the theoretical dilution rate is used. It depends on an alkali concentration, secondary additives, and a type of a solvent of a used alkaline coating solution, but a cleaning solution which provides a theoretical dilution of at least 1:100 to 1000, preferably 1:500 to 10000, more preferably 1:1000 to 100000 is used.

In using a certain amount of a cleaning solution L in a cleaning, a multi-stage cleaning method in which the cleaning apparatus 22 has multiple stages to divide and apply the cleaning solution L a plurality of times is more preferable than a method in which all of the cleaning solution L is applied at one time. That is, a proper time (distance) is provided between one cleaning solution spray nozzle 30 and a next cleaning solution spray nozzle 30 to achieve a dilution of an alkaline coating solution by dispersion. A multi-stage cleaning apparatus will be explained in detail later.

The cleaning solution L is preferably deionized water. The deionized water used in the present embodiment preferably has a specific electric resistance of at least 0.1 MΩ or more, and particularly, contains a metal ion such as sodium, potassium, magnesium, and calcium of less than 1 ppm, and an anion such as chloro and nitric acid of less than 0.1 ppm.

In the present invention, in the light of a cleaning ability, it is essential to maintain the temperature of the cleaning solution L at a room temperature or more. A higher temperature of the cleaning solution L facilitates the cleaning and removing of contaminant elements (e.g., alkaline solution). Therefore, the temperature of the cleaning solution L is preferably set within a range of 5 to 90 degrees C., more preferably 25 degrees C. to 80 degrees C., further more preferably 25 degrees C. to 60 degrees C., and most preferably at 37 degrees C.

A temperature control device (not shown) which controls a temperature of the cleaning solution L is preferably provided at the cleaning solution spray nozzle 30, the cleaning solution supplying pipe 31 for sending the cleaning solution L, or the like. The temperature control device may be various heaters, various heat insulating materials, a heat reserving material, or a method for maintaining an atmosphere temperature in the entire cleaning section at a predetermined temperature, but as long as the temperature is maintained at a predetermined level, other device may be used.

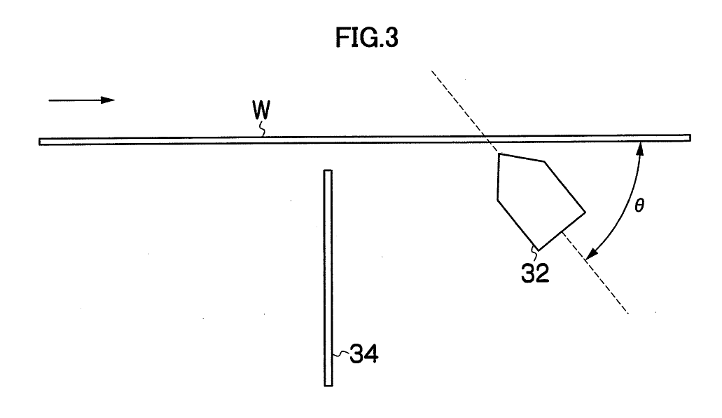

The gas ejection nozzle 32 is connected with an air pipe 33 which is provided with a blower 35. When a gas is force fed from the blower 35 to the gas ejection nozzle 32 via the air pipe 33, the gas is ejected toward the lower surface of the web W, and a part of the gas which is impinged against the web W forms an ejected gas flow, and flows in a direction opposite to the feeding direction of the web W. In this case, in order to efficiently form an ejected gas flow from the gas ejection nozzle 32, as shown in FIG. 3, the gas ejection nozzle 32 is disposed at an angle θ of 30 to 90 degrees, preferably 50 to 80 degrees, and most preferably 65 to 70 degrees, relative to the web W.

The gas ejection nozzle 32 is preferably an air knife. However, because a too large amount of air ejection may adversely affect the feeding stability of the web W and cause wave or wrinkle, there is a preferable range of the amount. It depends on an original water film thickness on the web W and a feeding speed of the web W, but typically, a wind speed of 10 to 500 m/sec, preferably 20 to 300 m/sec, more preferably 30 to 200 m/sec is used. In order to uniformly remove a liquid film, the air supplying manner to an air diffuser of the gas ejection nozzle 32 or the air knife is controlled to limit a wind speed distribution in the width direction of the web W to 10% or less, preferably 5% or less. As to the gap between the fed web surface and the ejection port of the gas ejection nozzle 32, a narrower gap enhances a dewatering performance, but increases the risk that the ejection port contacts and damages the web W, thereby there is a proper range of the gap. Typically, the gap is set within a range of 10 μm to 10 cm, preferably 100 μm to 5 cm, and more preferably 500 μm to 1 cm. In addition, a backup roll (not shown) may be provided to oppose to the gas ejection nozzle 32 on the opposite side of the surface to be cleaned of the web W. This stabilizes the setting of the gap, and also the adverse affects onto the web W such as waves, wrinkles, and deformations can be reduced.

The windshield wall 34 shields, as shown in FIG. 2, among the induced air E elements which are induced by the gas ejection from the gas ejection nozzle 32, by at least shielding the element of the induced air E which is induced from the cleaning solution L spraying position side toward the gas ejection position side, any reattachment of the droplets L₂ of the cleaning solution L removed from the web W to the lower surface of the web W (surface to be cleaned) and the gas ejection nozzle 32 can be prevented. The windshield wall 34 is disposed in a direction which is orthogonal to the feeding direction of the web W. The windshield wall 34 is formed to have a width which is equal to or 1.3 times that of the web W, and to have a thickness of 0.1 to 10 mm. Also the windshield wall 34 is preferably formed to have a height H1 which is 1.5 to 2 times the height H2 of the gas ejection nozzle 32.

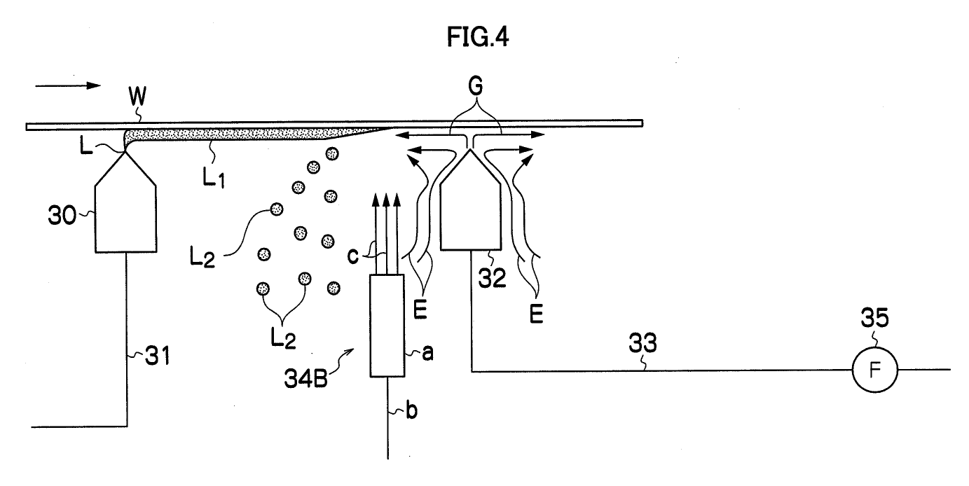

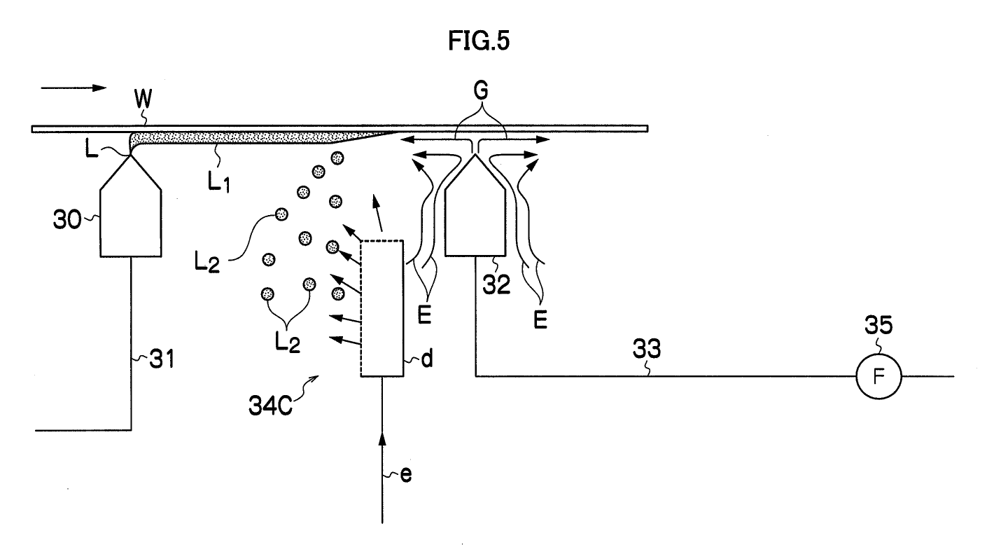

The windshield wall 34 may be preferably, for example, the plate shaped windshield 34A of FIG. 2, the air curtain forming apparatus 34B of FIG. 4, or the windshield box 34C of FIG. 5, but is not limited to these examples.

The air curtain forming apparatus 34B is formed by connecting a nozzle “a” having an ejection port which is long in the web width direction to an air piping “b”, and blows out a curtain-shaped air “c” toward the lower surface of the web W from the nozzle “a”. In this case, the blowing speed to form the curtain-shaped air “c” is preferably controlled to be within a range which does not cause waves of the web W and does not disturb the ejected gas flow from the gas ejection nozzle 32 to the web W.

The windshield box 34C of FIG. 5 includes a box body “d” having a top surface and a side toward the cleaning solution spraying nozzle which are formed of a porous material with an air piping “e” being connected to the box body “d”, so that a weak air stream is supplied from the air piping e to the inside of the box body d. The supplied air flows out of the box body “d” through the top surface and the side toward the cleaning solution spraying nozzle which are formed of a porous material. This clears the droplet L₂ which are attached to the box body “d”.

As shown in FIG. 2, the windshield wall 34 is provided with a position control device 37 which controls an arrangement position of the windshield wall 34. The position control device 37 causes the windshield wall 34 to move horizontally (the X-X direction) and vertically (the Z-Z direction) so that the windshield wall 34 fulfills both of its performance for removing the liquid film L₁ left on the web W and its performance for preventing any attachment of droplets. Not shown in FIG. 3 and FIG. 4, but a position control device 37 is also provided for the air curtain 34B and the windshield box 34C.

The present invention provides a structure with the windshield wall 34 which shields the induced air E from the cleaning solution L spraying position side toward the gas G ejecting position side, and is more effective in preventing any reattachment of the droplets L₂ removed from the web W to the web surface and the gas ejection nozzle 32 as compared to the prior art without the windshield wall 34. However, the present invention is further more effective when the windshield wall 34 is arranged at an appropriate position.

Next, a preferred arrangement position of the windshield wall 34 will be explained below.

In order to arrange the windshield wall 34 at a position where the windshield wall 34 fulfills both of its performance for removing the liquid film L₁ left on the web W and its performance for preventing any attachment of droplets, a tip (upper end) of the windshield wall 34 may be used as a reference.

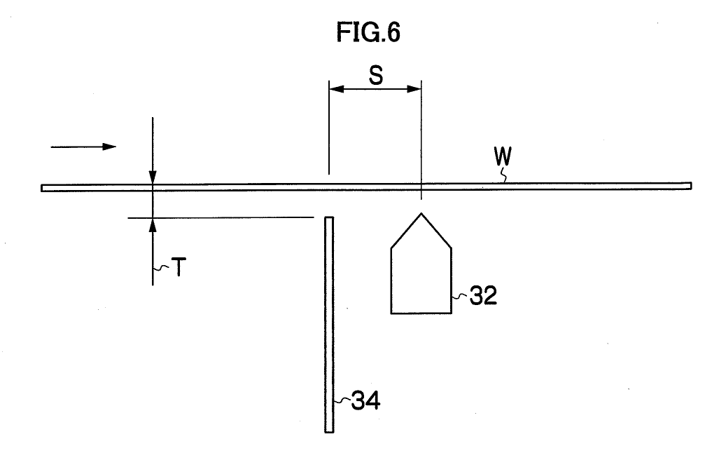

As shown in FIG. 6, with a distance S between the tip of the windshield wall 34 to the gas ejection nozzle 32 (the position of the ejection port) and a clearance T between the tip of the windshield wall 34 and the lower surface of the web W, the influences onto the performance for removing the liquid film L₁ left on the web W and the performance for preventing any attachment of droplets which are caused when the distance S and the clearance T were changed by the position control device 37 were examined.

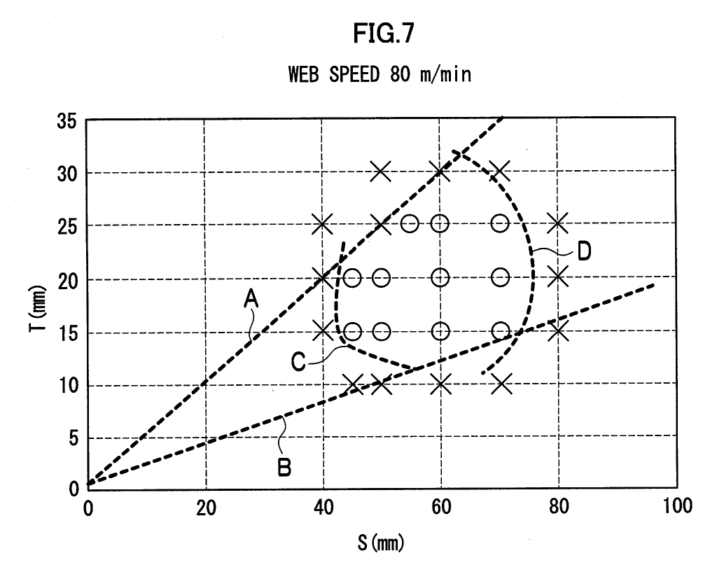

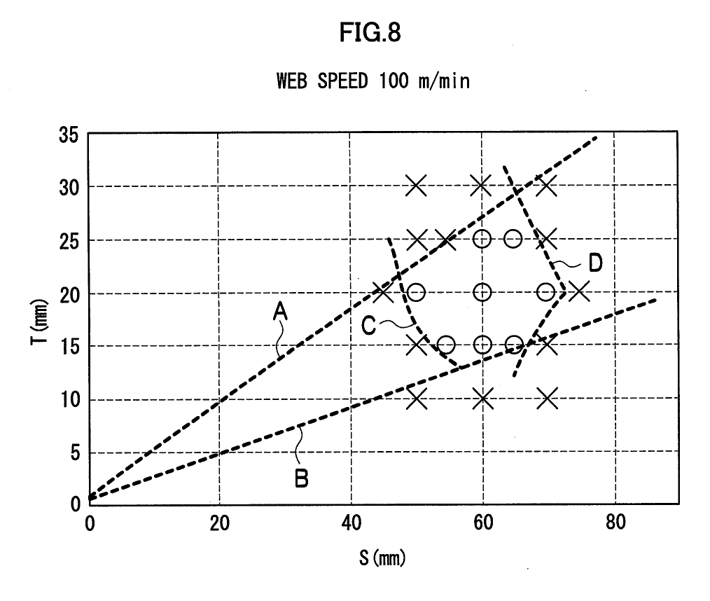

FIG. 7 shows a case where a cleaning was carried out at a gas ejection speed of 150 m/sec from the gas ejection nozzle 32 and a feeding speed of the web W of 80 m/min, and FIG. 8 shows a case where a cleaning was carried out at a gas ejection speed of 150 m/sec and a feeding speed of the web W of 80 m/min. In both of FIG. 7 and FIG. 8, the horizontal axis represents distance S, and the vertical axis represents clearance T. The circle symbol represents that both of the performance for removing the liquid film L₁ and the performance for preventing any attachment of droplets are well fulfilled, and the cross symbol represents that at least one of the removing performance and the attachment of droplets preventing performance is not well fulfilled.

As seen from FIG. 7, the circle symbols gather at an area where the distance S is within a range of over 40 mm to less than 80 mm and the clearance T is within a range of over 10 mm to less than 30 mm. In FIG. 8, the circle symbols gather at an area where the distance S is within a range of over 50 mm to less than 70 mm and the clearance T is within a range of over 15 mm to less than 25 mm.

As seen from the comparison between FIG. 7 and FIG. 8, a higher feeding speed of the web W makes the area surrounded by the dotted line A, the dotted line B, the dotted line C, and the dotted line D where the circle symbols gather smaller. Not shown, but a feeding speed of the web W of less than 80 m/min makes the area where the circle symbols gather larger. Similarly, any change of the ejection speed from the gas ejection nozzle 32 or the thickness of the liquid film L₁ left on the web W changes the area where the circle symbols gather. However, in order to securely obtain both of the performance for removing the liquid film L₁ left on the web W and the performance for preventing any attachment of droplets, the tip of the windshield wall 34 has to be arranged in the area where the circle symbols gather, independently from various factors such as a feeding speed, an ejection speed, and a thickness of the liquid film L₁.

Therefore, in order to arrange the tip of the windshield wall 34 in the area where the circle symbols gather using the position control device 37 independently from various factors, the area where the circle symbols gather has to be easily specified.

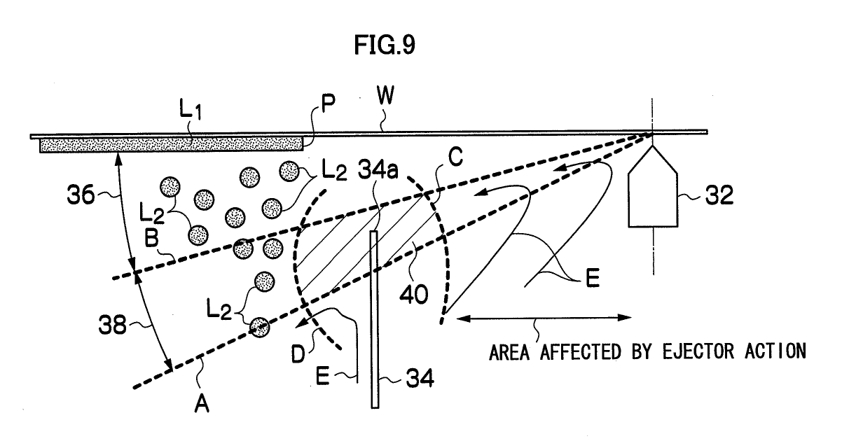

Thus, the inventor of the present invention intensively studied the way to specify an area surrounded by the dotted line A, the dotted line B, the dotted line C, and the dotted line D where the circle symbols gather. As a result, as shown in FIG. 9, the inventor found that the area where the circle symbols gather of FIG. 7 and FIG. 8 generally coincides with the most appropriate area 40 (the shaded area) which is surrounded by an ejector action border line (the dotted line C) for protecting the ejector action of a gas ejection and a wind speed border line (the dotted line D) which extends from the border position of a wind speed which enables dewatering of the liquid film L₁ on a surface of the web W in the ejected gas flow area 36 to a periphery area (the area surrounded by the dotted line A and the dotted line B), in the periphery area 38 which is outside of and adjacent to the ejected gas flow area 36 (the area surrounded by the web W and the dotted line B) which is formed in a flared shape from an ejection position of the gas ejection nozzle 32. The above description can be easily understood by comparing the vertically reversed figures of FIG. 7 and FIG. 8 with FIG. 9 where the horizontal axis of FIG. 7 and FIG. 8 corresponds to the web W of FIG. 9.

In order to specify the most appropriate area 40, first, the wind speed at a plurality of points on a downstream area of the web is measured using a velometer (not shown), so that the periphery area 38 which is located outside of and adjacent to the ejected gas flow area 36 and has a wind speed of generally zero can be specified. After the specification of the periphery area 38, the windshield wall 34 is caused to vertically move by the position control device 37 so as to arrange the tip 34a (upper end) of the windshield wall 34 in the periphery area 38. This disposes the tip 34a of the windshield wall 34 outside of the ejected gas flow area 36, thereby the ejected gas flow along the lower surface of the web W is not disturbed by the windshield wall 34. As a result, the performance for removing the liquid film L₁ left on the web W can be well fulfilled.

Next, the windshield wall 34 is caused to horizontally move by the position control device 37 to detect the ejector action border line (the dotted line C). If the windshield wall 34 is disposed beyond the ejector action border line and too close to the gas ejection nozzle 32, the ejector action is disturbed, which causes a lower wind speed of the ejected gas flow and the dewatering point P is shifted toward the gas ejection nozzle. If the dewatering point P is shifted toward the gas ejection nozzle, the droplets L₂ removed from the liquid film L₁ drop on the gas ejection nozzle side beyond the windshield wall 34, which increases the risk that the droplets L₂ reattach to the web portion after the removal of the liquid film L₁ and the gas ejection nozzle 32. Therefore, as the windshield wall 34 is moved toward the gas ejection nozzle, the movement has to be stopped before the dewatering point P is shifted toward the gas ejection nozzle. This enables the tip of the windshield wall 34 to be located closer to the gas ejection nozzle 32 than the dewatering point P is, which prevents the droplets L₂ removed from the liquid film L₁ from dropping on the gas ejection nozzle side beyond the windshield wall 34.

The above described arrangement of the windshield wall 34 allows the tip 34a of the windshield wall 34 to be located in the most appropriate area 40, that is, the area where the circle symbols for satisfying both of the removing performance and the droplets preventing performance gather.

Next, with reference to FIG. 9 to FIG. 13, the difference between a case where the tip 34a of the windshield wall 34 is arranged in the most appropriate area 40 and a case the tip 34a is not arranged in the most appropriate area 40 will be explained in detail below.

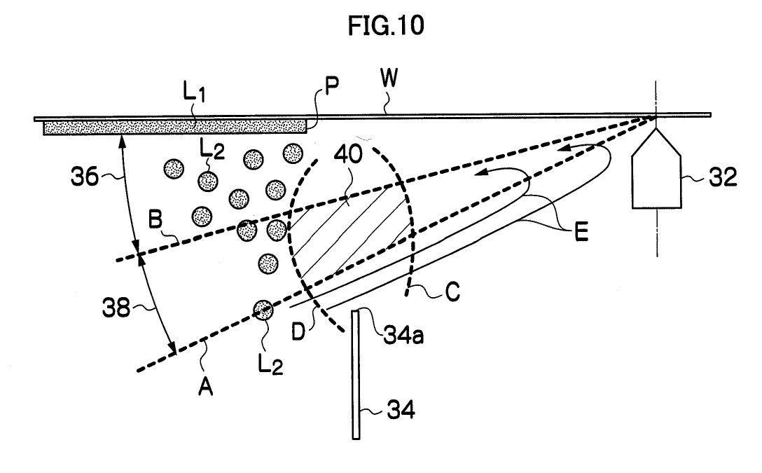

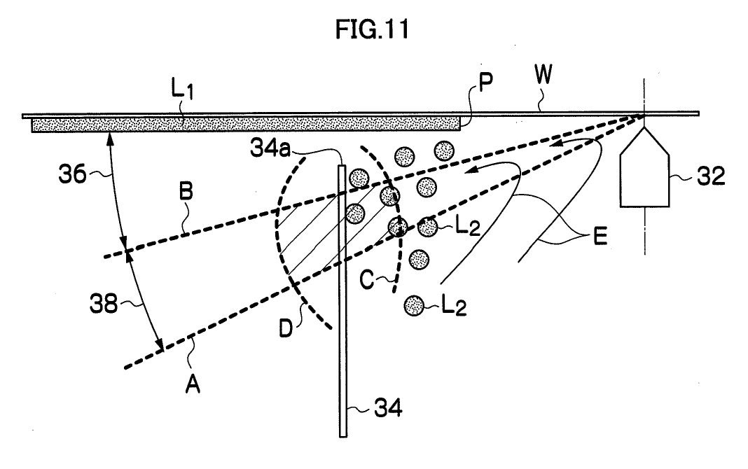

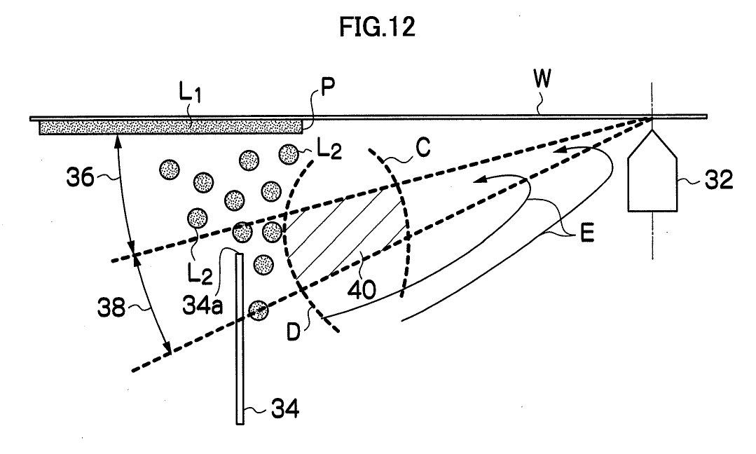

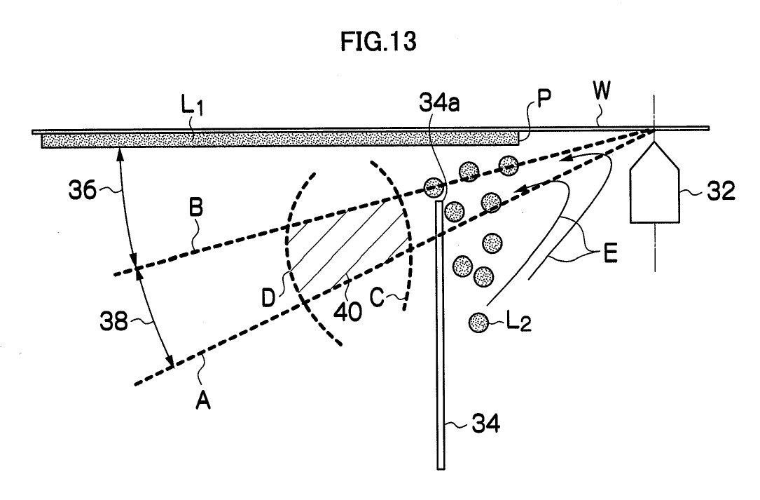

FIG. 9 shows a case where the tip 34a of the windshield wall 34 is arranged in the most appropriate area 40; FIG. 10 shows a case where the tip 34a is arranged below the line A (a case where the clearance T is too large); and FIG. 11 shows a case where the tip 34a is arranged above the line B (a case where the clearance T is too small). FIG. 12 shows a case where the tip 34a is arranged outside of the dotted line D (a case where the distance S is too large); and FIG. 13 shows a case where the tip 34a is arranged outside of the dotted line C (a case where the distance S is too small).

As seen from these figures, in the case of FIG. 9, the dewatering point P of the liquid film L₁ which is dewatered by the ejected gas flow from the gas ejection nozzle 32 is located closer to the cleaning solution spray nozzle than the windshield wall 34 is, and the induced air E which is induced by the ejector action is shielded by the windshield wall 34, thereby the droplets L₂ removed and dropped from the liquid film L₁ attach to the windshield wall 34, but the attachment to the web W and to the gas ejection nozzle 32 can be prevented.

FIG. 10 shows a case where the tip 34a of the windshield wall 34 is arranged below the line A, and the droplets L₂ removed and dropped from the liquid film L₁ are carried by the induced air E to the gas ejection nozzle side. This causes the reattachment of the droplets L₂ to the gas ejection nozzle 32 and the web portion after the removal of the liquid film L₁.

FIG. 11 shows a case where the tip 34a of the windshield wall 34 is arranged above the line B, and the tip 34a of the windshield wall 34 is in the ejected gas flow area 36. Thus, the ejected gas flow is disturbed, which causes a lower wind speed of the ejected gas flow and the dewatering point P is shifted closer to the gas ejection nozzle than the windshield wall 34 is. As a result, the droplets L₂ removed and dropped from the liquid film L₁ are carried by the induced air E, and reattach to the gas ejection nozzle 32 and the web portion after the removal of the liquid film L₁.

FIG. 12 shows a case where the tip 34a of the windshield wall 34 is arranged leftside of the dotted line D (on the cleaning solution spray nozzle side), and because the windshield wall 34 is too far from the gas ejection nozzle 32, the dewatering point P is formed at a position closer to the gas ejection nozzle than the windshield wall 34 is. As a result, the droplets L₂ removed and dropped from the liquid film L₁ drop on the gas ejection nozzle side of the windshield wall 34 and are carried by the induced air E, to reattach to the gas ejection nozzle 32 and the web portion after the removal of the liquid film L₁.

FIG. 13 shows a case where the tip 34a of the windshield wall 34 is arranged on the right side of the dotted line C (on the gas ejection nozzle side), and because the windshield wall 34 is too close to the gas ejection nozzle 32, the ejector action is disturbed by the windshield wall 34. This prevents the generation of induced air E, but decreases the wind speed of the ejected gas flow. As a result, the dewatering point P shifts beyond the windshield wall 34 to the gas ejection nozzle side, the droplets L₂ removed and dropped from the liquid film L₁ drop on the gas ejection nozzle side of the windshield wall 34 and are carried by the weak but generated induced air E, to reattach to the gas ejection nozzle 32 and the web portion after the removal of the liquid film L₁.

The above described method for arranging the tip 34a of the windshield wall 34 in the area where the circle symbols gather enables an appropriate arrangement using a concept of the periphery area 38, independently from various factors such as a feeding speed, an ejection speed, and a thickness of the liquid film L₁.

However, considering the slight influence of various factors such as a feeding speed, an ejection speed, and a thickness of the liquid film L₁, the tip 34a of the windshield wall 34 may be arranged so that a distance S and a clearance T satisfy the following range.

That is, a distance S is set in a range of from 5 to 200 mm, more preferably from 20 to 150 mm, and most preferably from 40 to 100 mm. A clearance T is set in a range of from 5 to 70 mm, more preferably from 8 to 50 mm, and most preferably from 10 to 30 mm.

In addition, the accuracy of a distance S and a clearance T in the width direction of the windshield wall 34 is essential to a uniform cleaning of the web W, and a distance S has to be controlled with an accuracy of ±10 mm, more preferably ±5 mm, and most preferably ±1 mm. A clearance T has to be controlled with an accuracy of ±5 mm, more preferably ±2 mm, and most preferably ±1 mm. The accuracy of a distance S and a clearance T is also essential when the tip 34a of the windshield wall 34 is arranged using the periphery area 38.

Next, an aspect of the present invention in which a cleaning apparatus 22 is provided at multiple stages will be explained below. In the present embodiment, an example with cleaning apparatuses at three stages will be used for the explanation.

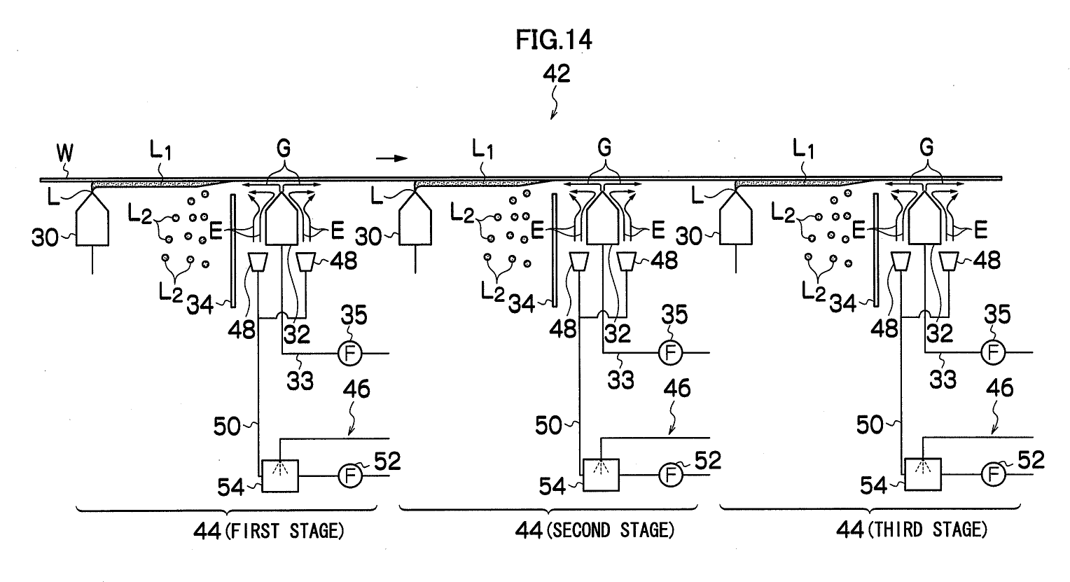

As shown in FIG. 14, the multi-stage cleaning apparatus 42 is configured with cleaning units 44 in three stages in series, each cleaning unit 44 being a set of a cleaning solution spray nozzle 30, a gas ejection nozzle 32, and a windshield wall 34. Furthermore, each cleaning unit 44 in the multi-stage cleaning apparatus 42 is provided with a wetting device 46 for feeding a surface of the web W (the surface to be cleaned) in a uniformly wetted state to a cleaning unit 44 in a next stage. The present embodiment will be explained by way of an example which has a humidifying nozzle 48 as the wetting device 46. The wetting device 46 includes a pair of humidifying nozzles 48, 48 which are disposed on both sides of the gas ejection nozzle 32 (upstream and downstream in the feeding direction of the web W) and connected to a humidifying pipe 50. The humidifying pipe 50 is provided with a blower 52 and a humidifier 54 along the humidifying pipe 50. This configuration allows a humidified gas (generally, air is used) to be ejected from the humidifying nozzle 48 toward the web W. The humidified gas directly humidifies the web W, and is also carried by the ejected gas flow from the gas ejection nozzle 32 to upstream and downstream of the feeding direction of the web W to humidify the web W.

In this way, the web W is fed to a cleaning unit 44 in a second stage in a uniformly wetted state without a complete removal of the cleaning solution L from the web W at the cleaning unit 44 in the first stage, thereby the cleaning solution L sprayed to the web W from the cleaning solution spray nozzle 30 in the second stage can be evenly coated on a surface of the web W. This enables a uniform cleaning of the web W. The feeding from the cleaning unit 44 in the second stage to a cleaning unit 44 in a third stage is carried out in the same way.

In the present embodiment, a pair of humidifying nozzles 48 are provided, but only one nozzle may be provided. Also, in the present embodiment, the example of the humidifying nozzle 48 was described as the wetting device 46, but a control device (not shown) for controlling a flow rate and/or amount of an ejected gas flow from the gas ejection nozzle 32 may be provided to control the removal amount of the cleaning solution L which is removed from the liquid film L₁. Furthermore, a vapor entraining device (not shown) may be provided to entrain the vapor (includes mist) of the cleaning solution L into the gas G ejected from the gas ejection nozzle 32.

### [Polymer Film (Web W)]

A polymer film (web W) which is used in the present embodiment preferably has a light transmittance of 80% or more. The web W is preferably a material which is not likely to induce a birefringence by an external force. The web W contains a hydrolysable bond such as an ester bond and an amino bond (a bond to be subjected to a saponification process). An ester bond is preferable, and an ester bond at a polymer side chain is more preferable. A representative example of a polymer having an ester bond at its side chain is cellulose ester. Lower fatty acid ester of cellulose is more preferable, cellulose acetates further more preferable, and cellulose acetate having a degree of acetyl substitution of 59.0 to 61.5% is the most preferable. A degree of acetyl substitution means the amount of bound acetic acid per a cellulose unit mass. A degree of acetyl substitution complies with the measurement and calculation for an acetylation degree according to ASTM D-817-91 (a test method for cellulose acetate for example).

A viscosity average polymerization degree (DP) of cellulose ester is preferably 250 or more, more preferably 290 or more. The cellulose ester used in the present invention preferably has a narrow molecular weight distribution Mw/Mn (Mw: a weight-average molecular weight, Mn: a number average molecular weight) as determined by a gel permeation chromatography. Specifically, the value Mw/Mn is preferably 1.0 to 1.7.

When the web W is used in an optical compensatory sheet, the web W preferably has a high retardation value. An Re retardation and an Rth retardation value of the web W are defined by the following formulas (I) and (II):

### [Formula 2]

Re=¦nx−ny¦×d (I)

### [Formula 3]

Rth={(nx+ny)/2−nz}×d (II)

In Formula (I) and (II), nx is a refractive index in a slow axis direction in a web W plane (the direction giving the maximum refractive index), ny is a refractive index in a fast axis direction in a web W plane (the direction giving the minimum refractive index), nz is a refractive index in a thickness direction of the web W, d is a thickness (nm) of the web W. The web W preferably has an Re retardation value of 1 to 200 nm, and an Rth retardation value of 70 to 400 nm. The specific values are obtained by extrapolation using the measurement results by inclining the incident direction of a measuring beam relative to the vertical direction of a web W film surface. The measurement can be carried out using an ellipsometer (for example, M-150 manufactured by JASCO Corporation). A measuring wavelength of 632.8 nm (He—Ne laser) is used.

Generally, an external force such as stretching is applied to adjust retardation of the web W, but in some cases, a retardation enhancer is added for adjustment of an optical anisotropy. In order to adjust retardation of a cellulose acrylate film, an aromatic compound having at least two aromatic rings is preferably used as a retardation enhancer. The aromatic compound is preferably used within a range of 0.01 to 20 mass parts relative to cellulose acylate of 100 mass parts. Also, two or more aromatic compounds may be used together. The aromatic ring of an aromatic compound includes an aromatic hydrocarbon ring as well as an aromatic heterocyclic ring.

The polymer film is preferably manufactured by a solvent casting method. In the solvent casting method, a solution (dope) of a polymer material dissolved in an organic solvent is used to manufacture a film. The organic solvent preferably includes a solvent which is selected from the group consisting of ethers having 3 to 12 carbon atoms, ketones having 3 to 12 carbon atoms, esters having 3 to 12 carbon atoms, and halogenated hydrocarbons having 1 to 6 carbon atoms. The ethers, ketones, and esters may have a ring-shaped structure. Alternatively, compounds which have two or more of the functional groups (i.e., —O—, —CO—, and —COO—) of ethers, ketones, and esters may be used as an organic solvent. The organic solvent may have other functional group such as an alcoholic hydroxyl group. The organic solvent having two or more functional groups may have the number of the carbon atoms within a specified range for a compound having any one of the functional groups.

The examples of ethers having 3 to 12 carbon atoms include diisopropylether, dimethoxymethane, dimethoxyethane, 1,4-dioxane, 1,3-dioxolane, tetrahydrofuran, anisole, and phenetole. The examples of ketones having 3 to 12 carbon atoms include acetone, methyl ethyl ketone, diethyl ketone, diisobutyl ketone, cyclohexanone, and methylcyclohexanone. The examples of esters having 3 to 12 carbon atoms include ethyl formate, propyl formate, pentyl formate, methyl acetate, ethyl acetate, and pentyl acetate. The examples of compounds having two or more functional groups include 2-ethoxyethyl acetate, 2-methoxy ethanol, and 2-butoxyethanol. The halogenated hydrocarbons preferably have one or two carbon atoms, most preferably one carbon atom. The halogen in the halogenated hydrocarbons is preferably chlorine. The substitution ratio for substitution of hydrogen atoms in halogenated hydrocarbons with halogen is preferably 25 to 75 mol %, more preferably 30 to 70 mol %, further more preferably 35 to 65 mol %, and most preferably 40 to 60 mol %. Methylene chloride is a representative example of halogenated hydrocarbons. Additional two or more organic solvents may be mixed to use.

The polymer solution can be prepared using a general method. The general method means a processing at a temperature above 0 degrees C. (a normal temperature or a high temperature). The preparation of a solution can be carried out using a dope preparation method and apparatus in a normal solvent casting method. In using the general method, halogenated hydrocarbon (especially, methylene chloride) is preferably used as an organic solvent. The polymer is prepared to be contained in the resulting solution by 10 to 40 mass %. The polymer amount is more preferably 10 to 30 mass %. The organic solvent (main solvent) may be added with any additive which will be described later. The solution can be prepared by agitating a polymer and an organic solvent at a normal temperature (0 to 40 degrees C.). A solution having a high concentration may be agitated under pressure and a heating condition. Specifically, a polymer and an organic solvent are poured and sealed in a pressurized container, which is heated and agitated under pressure at a temperature which is above the boiling point of the solvent at a normal temperature and at which the solvent is not boiled. The heating temperature is typically 40 degrees C. or more, preferably 60 to 200 degrees C., and more preferably 80 to 110 degrees C.

The components of the solution may be roughly mixed in advance to be poured in a container. Alternatively, the components may be serially poured into a container. The container has to have a configuration which allows an agitation. An inert gas such as nitrogen gas may be injected into the container to pressurize the container. A rising pressure of vapor of a solvent upon heating may be used. Alternatively, after the container is sealed, each component may be added under pressure. When a heating is used, the container is preferably heated from its outside. For example, a heating apparatus having a jacket structure may be used. Alternatively, a plate heater may be provided outside of the container to connect piping so that the entire container can be heated by circulating a liquid through the piping. The agitation is preferably carried out by providing an agitation blade in the container and using the blade. The agitation blade preferably has a length that almost reaches a wall of the container. The agitation blade preferably has a scraper blade at the tip thereof to reconstitute a liquid film on the wall of the container. The container may be provided gauge equipment such as a manometer and a thermometer. Each component is dissolved in a solvent in the container. The prepared dope is cooled and removed out of the container, or is cooled using a heat exchanger or the like after the removal.

The solution may be prepared using a cooling dissolution method. The use of a cooling dissolution method enables dissolution of a polymer into an organic solvent in which the polymer is hardly dissolved when a normal dissolving method is used. When a solvent which can dissolve a polymer by a normal dissolving method is used in the cooling dissolution method, a homogenous solution can be quickly obtained. In the cooling dissolution method, first, a polymer is added little by little to an organic solvent with agitation at a room temperature little by little. The amount of the polymer is preferably adjusted to be contained in the mixture by 10 to 40 mass %. The amount of the polymer is more preferably 10 to 30 mass %. Furthermore, the mixture may be added with any additives which will be described later.

Next, the mixture is cooled to the temperature of −100 to −10 degrees C., preferably −80 to −10 degrees C., further more preferably −50 to −20 degrees C., and most preferably −50 to −30 degrees C. The cooling may be carried out in dry ice, a methanol bath (−75 degrees C.), or a cooled diethylene glycol solution (−30 to −20 degrees C.). Such a cooling makes the mixture of a polymer and an organic solvent solidified. The cooling speed is preferably 4 degrees C./min or more, more preferably 8 degrees C./min or more, and most preferably 12 degrees C./min or more. Herein, the cooling speed is the value obtained by dividing the difference between the temperature at the beginning of cooling and the resulting temperature after the cooling by the time from the beginning of cooling to the end of cooling when the final cooled temperature was reached.

Then, a heating of the mixture to the temperature of 0 to 200 degrees C., preferably 0 to 150 degrees C., more preferably 0 to 120 degrees C., and most preferably 0 to 50 degrees C. makes the polymer in the organic solvent dissolved. The temperature may be risen by leaving the mixture at a room temperature, or heating the mixture in a hot bath. The heating speed is preferably 4 degrees C./min or more, more preferably 8 degrees C./min or more, and most preferably 12 degrees C./min or more. Herein, the heating speed is the value obtained by dividing the difference between the temperature at the beginning of heating and the resulting temperature after the heating by the time from the beginning of heating to the end of heating when the final heated temperature was reached. In this way, a homogenous solution can be obtained. In case the dissolution is not enough, the cooling and heating operation may be repeated. The degree of dissolution can be determined by visually observing the appearance of a solution.

In the cooling dissolution method, an airtight container is desirably used to avoid any entrance of moisture due to a dew formation in the cooling operation. Also, in the cooling and heating operation, a combination of a pressure application in the cooling operation and a pressure reduction in the heating operation reduces the time for dissolution. For the pressure application and pressure reduction, a pressure tight container is desirably used. In a solution having cellulose acetate (a degree of acetylation: 60.9%, a viscosity average polymerization degree: 299) dissolved in methyl acetate by the cooling dissolution method by 20 mass %, according to a differential scanning calorimetry (DSC), there is a pseudophase transition between a sol state and a gel state near the temperature of 33 degrees C., and at a temperature below 33 degrees C., the solution reaches a gel state. Therefore, the solution needs to be maintained at a temperature at a pseudo phase transition temperature or more, preferably around at a gel phase transition temperature+10 degrees C. However, the pseudo phase transition temperature depends on a acetylation degree of cellulose acetate, a viscosity average polymerization degree, a solution concentration, an organic solvent in use.

The prepared polymer solution (dope) is first coated to form a polymer film by a solvent casting method. The dope is cast on a drum or band to evaporate the solvent therein to form a film. The dope before the casting is preferably adjusted to have a solid content concentration of 18 to 35%. The drum or band preferably has a surface which is processed to a mirror finish. The dope is preferably cast on the drum or band having a surface temperature of 10 degrees C. or less. After the casting, the dope is preferably dried by applying an air for two seconds or more. The obtained film is peeled off from the drum or band, which may be further dried by applying a hot air at a sequentially changed temperature from 100 to 160 degrees C. to evaporate the left solvent. This reduces the time from the casting to the peeling off. In order to implement this method, a gel formation of the dope at the surface temperature of a drum or band at the time of casting is essential.

The web W may be added with a plasticizer to improve its mechanical property or enhance a drying rate. The plasticizer may be phosphoric acid ester or carboxylic acid ester.

Furthermore, the web W of the present embodiment may be added with a plasticizer to improve its mechanical property or enhance a drying rate. The plasticizer may be phosphoric acid ester or carboxylic acid ester. The amount of the added plasticizer is preferably 0.1 to 25 mass % of cellulose ester content, more preferably 1 to 20 mass, and most preferably 3 to 15 mass %.

Furthermore, the web W of the present embodiment may be added with various additives (for example, ultraviolet preventing agents, particulates, release agents, antistatic, antidegradant (e.g., antioxidant, peroxide decomposer, radical inhibitor, metal deactivators, acid trapping agent, and amine), and infrared absorbent) depending on the application to use the film, and the additives may be a solid or an oil like substance. When the web W is formed of multiple layers, the type and amount of the added addictives may be different for each layer. The using amounts of the additives are not specifically limited as far as the amount of each substance is enough to effectively function, but each additive is preferably appropriately used within a range of 0.001 to 20 mass % in all compositions of the web W.

The web W may be stretched to adjust its retardation. The stretching rate is preferably 3 to 100%. The polymer film preferably has a thickness of 30 to 200 μm, more preferably 40 to 120 μm.

### [Alkaline Solution]

The alkaline solution used in the present embodiment can be prepared by dissolving an alkali in water or a mixture solution of water and an organic solvent. A preferred organic solvent is one or a plurality of the organic solvent selected from the group consisting of alcohols having eight carbon atoms or less, ketones having six carbon atoms or less, esters having six carbon atoms or less, polyhydric alcohols having six carbon atoms or less.

The examples of the above organic solvents include monohydric alcohols (e.g., methanol, ethanol, n-propanol, isopropanol, n-butanol, isobutanol, 2-butanol, cyclohexanol, benzyl alcohol, and fluorinated alcohol), ketones (e.g., acetone, methyl ethyl ketone, and methyl isobutyl ketone), esters (e.g., methyl acetate, ethyl acetate, and butyl acetate), polyhydric alcohols (e.g., ethylene glycol, diethylene glycol, propylene glycol, and glycerin), amides (e.g., N,N-dimethylformamide, and dimethylformamide), sulfoxides (e.g., dimethyl sulfoxide), and ethers (e.g., methyl cellosolve, and ethylene glycol diethyl ether). Among these, methanol, ethanol, n-propanol, isopropanol, n-butanol, isobutanol, 2-butanol, acetone, methyl ethyl ketone, methyl isobutyl ketone, methyl acetate, ethyl acetate, ethylene glycol, diethylene glycol, propylene glycol, and glycerin are particularly preferred.

The organic solvent should be a solvent which does not make the web W dissolved or swollen. In addition, to facilitate a coating of an alkaline saponification solution, as described in the paragraph for liquid properties of an alkaline solution, an organic solvent having an appropriately low surface tension is desirably selected. The using ratio of an organic solvent in a solvent is determined depending on a type of the solvent, its miscibility (solubility) with water, its reaction temperature and reaction time. In order to complete a saponification reaction in a short time, a solution having a high concentration is preferably prepared. However, because a solution having a too high concentration of a solvent causes an extraction of a component (plasticizer and the like) in the web W and an excess swelling of the web W, an appropriate concentration should be selected. The mixture ratio of water and an organic solvent is preferably 3/97 to 85/15 mass ratio, more preferably 5/95 to 60/40 mass ratio, and further more preferably 15/85 to 40/60 mass ratio. The mixture ratio within the above listed ranges facilitates a saponification process over the entire web W surface without damaging the optical properties of the web W.

The alkaline reagent of the alkaline solution may be inorganic base or organic base. A strong base is preferred to obtain a saponification reaction at a low concentration. Alkali metal hydroxides (e.g., NaOH, KOH, and LiOH), amines (e.g., perfluoro tributyl amine, triethyl amine, diazabicyclo nonen, and diazabicycl undecene), tetraalkyl ammonium hydroxides (as an alkyl group, methyl group, ethyl group, propyl group, and butyl group), and free bases of complex salt (e.g., [Pt(NH₃)₆](OH)₄) are preferable, a hydroxide of an alkali metal is more preferable, and NaOH and KOH are most preferable.

The concentration of the alkaline solution is determined depending on the type of an alkali used, its reaction temperature and reaction time. In order to complete a saponification reaction in a short time, a solution having a high concentration is preferably prepared. However, a solution having a too high alkali concentration may damage the stability of the alkaline solution, and cause precipitation after a long time coating. The alkaline solution preferably has a concentration of 0.1 to 5 normalities (N), more preferably 0.5 to 5 N, and most preferably 0.5 to 3 N.

The alkaline solution used in the present embodiment may contain a surfactant. An addition of a surfactant stabilizes any substance of the web W extracted by the organic solvent in the alkaline solution, and does not cause precipitation or condensation of the extracted substance in a following water washing step.

The above described surfactant may be any one without any specific limitation as long as it can be dissolved or dispersed in the alkaline saponification solution of the present invention. Any one of nonionic surfactants and ionic surfactants (anionic, cationic, and amphoteric surfactant) may be preferably used, but a nonionic surfactant and an anionic surfactant is particularly preferable to use in terms of solubility and saponification properties (see Japanese Patent Application Laid-Open No. 2003-313326).

Also, The above described surfactant may be added with an organic solvent other than the above described organic solvent, a fungicide, an antifungal agent, and other additives (for example, an alkaline fluid stabilizing agent (e.g., antioxidant agent), water soluble compounds (e.g., polyalkylene glycols, and natural water soluble resins)) as a surfactant for the alkaline solution and a dissolution aid of an antifoaming agent.

The water used in the alkaline solution of the present embodiment is preferably the water in consideration of the influence of each element and mineral in the water which is specified in Japanese Waterworks Law (Law No. 177 of 1957) and the ministerial ordinance with respect to the water quality standards based on the Waterworks Law (Ministry of Health, Labour and Welfare Ordinance No. 56 of 31 Aug. 1978), Japanese Hot Springs Law (Law No. 125 of 10 Jul. 1948 and the appendix) and the International Drinking Water Standard set by WHO.

An alkaline solution used in the present embodiment has liquid properties based on the above described compositions, and preferably has a surface tension of 45 mN/m or less and a viscosity of 0.8 to 20 mPa·s. Also, the alkaline solution preferably has a density of 0.65 to 1.05 g/cm³. This setting facilitates the application of the alkaline solution in a stable coating operation in accordance with a feed speed, and enables the achievement of a wettability of the solution to the web W surface, a retention of the coated solution to the web W surface, a removability of the alkaline fluid from the web W surface after a saponification process.

### EXAMPLES

Next, the present invention will be explained in further detail by way of examples, but the present invention is not limited to the following examples.

### Example A

In Example A, the behavior of the droplets L₂ removed and dropped from the web W was visually tested in a case with the windshield wall 34 and a case without the windshield wall 34.

In the alkaline solution coating apparatus 14 in the alkaline saponification process line 10 of FIG. 1, an alkaline solution (1 normality, KOH solution) was coated at a rate of 14 cc/m² on one surface side of an elongated web W of a cellulose acetate film (thickness: 100 μm, width: 1895 mm). Then, at a temperature of 110 degrees C. for about 7 seconds, the web W was subjected to an alkaline saponification process, and in the reaction stopping apparatus 18, deionized water was coated at a rate of 3 cc/m² on the alkaline solution for dilution. After the coating, the web W was cleaned in the cleaning apparatus 22. The feeding speed of the web W in the alkaline saponification process line 10 was 100 m/min.

In the cleaning apparatus 22, deionized water at a temperature of 37 degrees C. was sprayed to the one surface of the web W (the surface to be cleaned) from the cleaning solution spray nozzle 30 at a spraying speed of 100 cm/sec, and also an air was ejected from the gas ejection nozzle 32 (an air knife was used) at an ejection wind speed of 150 m/sec to form an ejected gas flow, so that the water film left on the web W was removed.

In Example A, the windshield wall 34 (a windshield plate 34A was used) was interposed between the cleaning solution spray nozzle 30 and the gas ejection nozzle 32 to provide a distance S of 60 mm and a clearance T of 20 mm. To the contrary, in Comparative Example, the windshield wall 34 was not interposed.

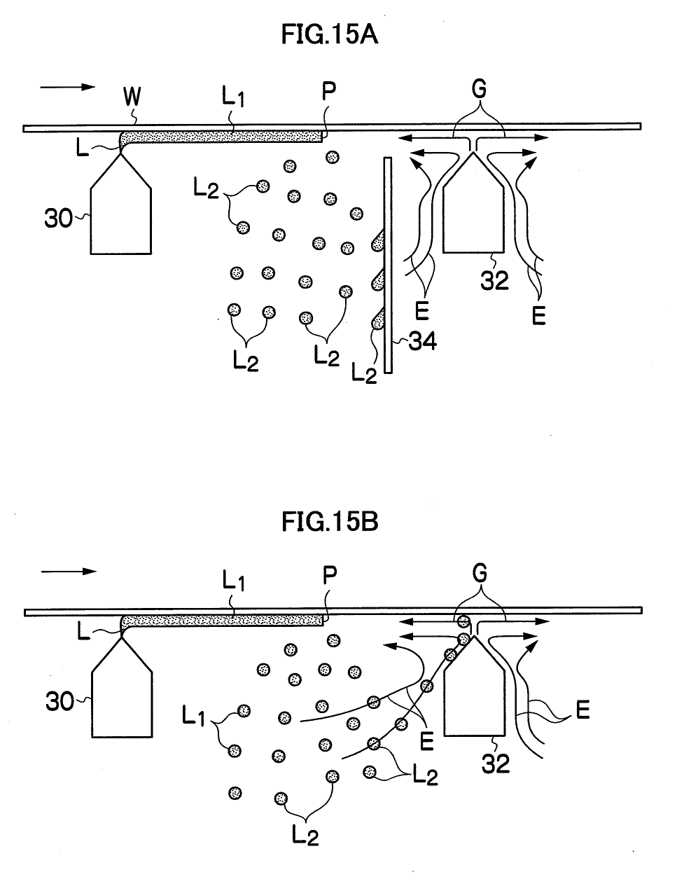

The test results will be explained by way of a schematic diagram of FIGS. 15A and 15B. FIG. 15A shows Example A with the windshield wall 34, and FIG. 15B shows Comparative Example without the windshield wall 34.

As seen from FIG. 15A, among the induced air E which is induced by the air ejection from the gas ejection nozzle 32, the induced air E which flows from the cleaning solution spray nozzle side toward the gas ejection nozzle side is shielded by the windshield wall 34. This allows the droplet L₂ removed and dropped from the water film L₁ on the web W to be dropped by the ejected gas flow from the gas ejection nozzle 32 on the cleaning solution spray nozzle side beyond the windshield wall 34, which prevents the droplet L₂ removed from the water film L₁ on the web W from reattaching to the cleaned portion of the web W and the gas ejection nozzle 32. Therefore, even in a case of an agent cleaning where a chemical reaction is taking place during the cleaning, a uniform cleaning could be achieved without unevenness, and also the ejection port of the gas ejection nozzle 32 was not clogged with scales in the droplets.

To the contrary, in Comparative Example of FIG. 15B, the droplet L₂ removed from the water film L₁ on the web W were carried by the induce air E, and reattached to the cleaned portion of the web W and the gas ejection nozzle 32. This caused uneven cleaning at the web portion with the droplets, and also the ejection port of the gas ejection nozzle 32 was clogged with scales in the droplets.

### Example B

In Example B, the effect of a wet processing was tested using the multi-stage cleaning apparatus 42 of FIG. 14 which has cleaning units 44 at three stages. The configuration was similar to Example A except a pair of humidifying nozzles 48, 48 were provided on both sides of the gas ejection nozzle 32 of each cleaning unit 44.

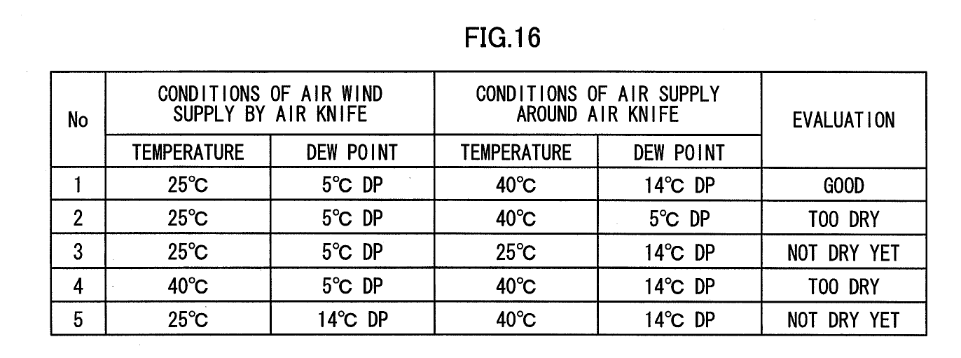

As shown in Table of FIG. 16, the cleaned state of a web surface was observed by changing a temperature and a dew point of an air ejected from the gas ejection nozzle 32 of the cleaning unit 44 in a first stage, and a temperature and a dew point of an air ejected from the pair of humidifying nozzles 48, 48.

Test 1 shows a case where an air, having a low temperature (25 degrees C.) and being dry (5 degrees CDP), was ejected from the gas ejection nozzle 32, while an air, having a high temperature (40 degrees C.) an being wet (40 degrees CDP), was ejected from the humidifying nozzles 48. As a result, the web surface after the first stage was in a uniformly wetted state, and the deionized water sprayed to the web surface from the cleaning solution spray nozzle 30 at the second stage was uniformly coated. The result from the second to the third stage was the same. In this way, a uniform cleaning at multiple stage could be achieved, and there was no unevenness in the saponification reaction in the cleaning.

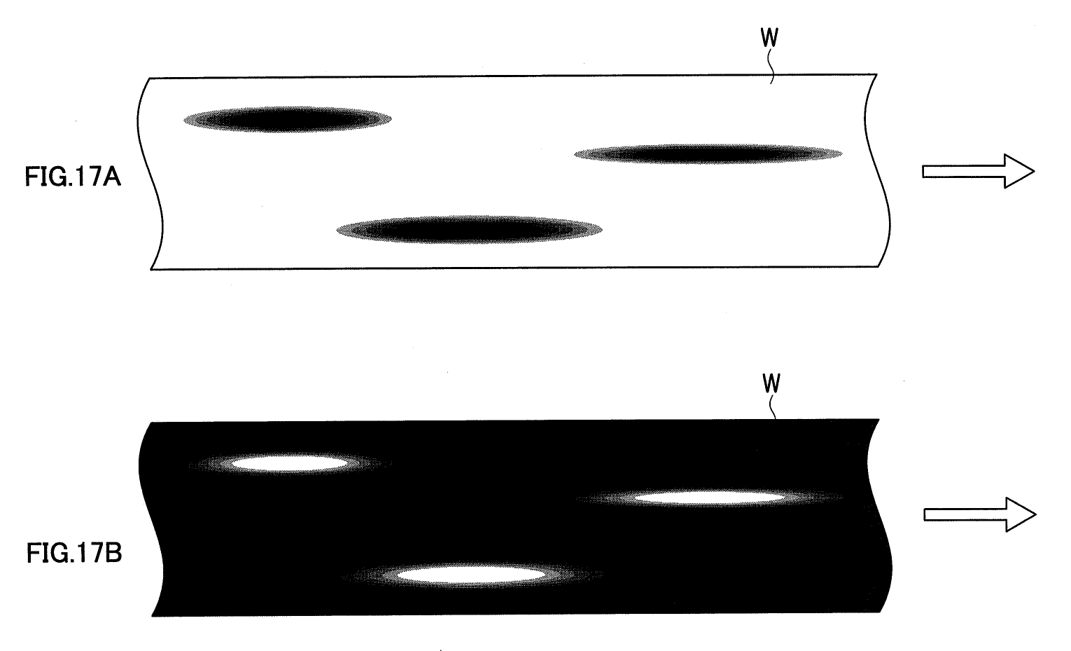

Test 2 shows a case where an air, having a higher temperature (40 degrees C.) than that from the gas ejection nozzle 32 and being dry (5 degrees CDP), was ejected from the humidifying nozzle 48, and the other conditions were similar to Test 1. As a result, the web surface after the first stage was too dry like that of FIG. 17A, and wet portions (dark portions) were partly observed. That is, a uniformly wetted state was not formed. Due to the ununiform state, the deionized water sprayed to the web surface from the cleaning solution spray nozzle 30 at the second stage was not likely to be coated at the too dry portions, resulting in an uneven cleaning, and an uneven saponification reaction in the cleaning. The obtained product was regarded as a defective.

Test 3 shows a case where an air, having the same temperature (25 degrees C.) as that from the gas ejection nozzle 32 and being wet (14 degrees CDP), was ejected from the humidifying nozzles 48, and the other conditions were similar to Test 1. As a result, the web surface after the first stage was too wet like that of FIG. 17B, and dry portions (white portions) were partly observed. That is, a uniformly wetted state was not formed. Due to the ununiform state, the deionized water sprayed to the web surface from the cleaning solution spray nozzle 30 at the second stage was not likely to be coated at the too dry portions, resulting in an uneven cleaning, and an uneven saponification reaction in the cleaning. The obtained product was regarded as a defective.

Test 4 shows a case where an air, having a high temperature (40 degrees C.) and being dry (5 degrees CDP), was ejected from the gas ejection nozzle 32, and the other conditions were similar to Test 1. As a result, similar to Test 2, the surface was in a too dry state and the cleaning was unevenly carried out, resulting in an uneven saponification reaction in the cleaning.

Test 5 shows a case where an air, having a low temperature (25 degrees C.) and being wet (14 degrees CDP), was ejected from the gas ejection nozzle 32, and the other conditions were similar to Test 1. As a result, similar to Test 3, the surface was in a too wet state and the cleaning was unevenly carried out, resulting in an uneven saponification reaction in the cleaning.

The above results indicate that, in a cleaning at multiple stages, a feeding of a web in a uniformly wetted state to a cleaning apparatus at a next stage is essential for a uniform cleaning.

What is claimed is:

1. A method for cleaning a web-like object to be cleaned, comprising the steps of:
a cleaning solution spraying step for spraying a cleaning solution to a surface of a fed web-like object to be cleaned; and
a cleaning solution removing step for removing the liquid film left on the surface of the object to be cleaned by ejecting a gas so that at least an ejected gas flow is formed in a direction opposite to the feeding direction of the object to be cleaned, wherein
among the air induced by the gas ejection, the air induced from the side of the cleaning solution spraying position to the side of the gas ejection position is shielded.

2. The method for cleaning a web-like object to be cleaned according to claim 1, wherein
the surface of the object to be cleaned is coated with an agent for a chemical reaction with respect to the object to be cleaned, and is cleaned with the cleaning solution in order to stop the chemical reaction of the agent.

3. The method for cleaning a web-like object to be cleaned according to claim 2, wherein
the object to be cleaned is a polymer film, and the agent is an alkaline fluid for alkaline saponification process of the polymer film.

4. The method for cleaning a web-like object to be cleaned according to claim 1, further comprising the steps of:
a step for detecting an outer edge of an ejected gas flow which is formed in a direction opposite to the feeding direction of the object to be cleaned; and
a step for arranging a tip of a windshield wall which shields the induced air at the outer edge based on the detected result.

5. The method for cleaning a web-like object to be cleaned according to claim 1, wherein
the cleaning solution spraying step and the cleaning solution removing step are carried out as a set of cleaning steps at multiple stages, and at each cleaning step, a wet processing is implemented so that the object to be cleaned is fed with the surface of the object to be cleaned maintained in a uniformly being wetted state to a cleaning step at a next stage.

6. The method for cleaning a web-like object to be cleaned according to claim 5, wherein
the wet processing comprises a step of controlling of a flow rate and/or amount of the ejected gas flow.

7. The method for cleaning a web-like object to be cleaned according to claim 5, wherein
the wet processing comprises a step of entraining of the vapor of the cleaning solution in the gas which forms the ejected gas flow.

8. The method for cleaning a web-like object to be cleaned according to claim 5, wherein
the wet processing comprises a step of ejecting of a humidifying gas to humidify the surface of the object to be cleaned as well as an ejected gas flow which removes the cleaning solution from the surface of the object to be cleaned.

9. The method for cleaning a web-like object to be cleaned according to claim 1, wherein
the surface to be cleaned of the fed object to be cleaned is the lower surface of upper and lower surfaces of the object to be cleaned.

10. An apparatus for cleaning a web-like object to be cleaned, comprising:
a cleaning solution spray nozzle which sprays a cleaning solution to a surface of a fed web-like object to be cleaned; and
a gas ejection nozzle which ejects a gas so as to form at least an ejected gas flow in a direction opposite to the feeding direction of the object to be cleaned to remove the liquid film left on the surface of the object to be cleaned; wherein
a windshield wall is interposed between the cleaning solution spray nozzle and the gas ejection nozzle in a direction which is orthogonal to the feeding direction of the object to be cleaned.

11. The apparatus for cleaning a web-like object to be cleaned according to claim 10, wherein
the windshield wall shields the air induced from the side of the cleaning solution spraying position to the side of the gas ejection position among the air which is induced by the gas ejection.

12. The apparatus for cleaning a web-like object to be cleaned according to claim 10, wherein
the windshield wall is a plate shaped windshield.

13. The apparatus for cleaning a web-like object to be cleaned according to claim 10, wherein
the windshield wall is an air curtain.

14. The apparatus for cleaning a web-like object to be cleaned according to claim 10, wherein
the windshield wall is a windshield box formed of porous plates, and the windshield box blows out a weak air stream.

15. The apparatus for cleaning a web-like object to be cleaned according to claim 10, wherein
the surface of the object to be cleaned is coated with an agent for a chemical reaction with respect to the object to be cleaned, and the agent is cleaned with the cleaning solution in order to stop the chemical reaction of the agent.

16. The apparatus for cleaning a web-like object to be cleaned according to claim 15, wherein
the object to be cleaned is a polymer film, and the agent is an alkaline fluid for alkaline saponification process of the polymer film.

17. The apparatus for cleaning a web-like object to be cleaned according to claim 10, further comprising:
a position control device which controls an arrangement position of the windshield wall.

18. The apparatus for cleaning a web-like object to be cleaned according to claim 17, further comprising:
a detecting device which detects an outer edge of an ejected gas flow which is formed in a direction opposite to the feeding direction of the object to be cleaned, so that a tip of the windshield wall is arranged at the outer edge based on the detection result by the position control device.

19. The apparatus for cleaning a web-like object to be cleaned according to claim 10, wherein
the cleaning solution ejection nozzle and the gas ejection nozzle are provided as a set of cleaning unit at multiple stages, and each cleaning unit is provided with a wetting device which feeds the object to be cleaned with the surface of the object to be cleaned being maintained in a uniformly wetted state to a cleaning unit of a next stage.

20. The apparatus for cleaning a web-like object to be cleaned according to claim 19, wherein
the wetting device is a device which controls a flow rate and/or amount of an ejected gas flow from the ejection nozzle.

21. The apparatus for cleaning a web-like object to be cleaned according to claim 19, wherein
the wetting device is a device which entrains vapor of a cleaning solution into the gas ejected from the gas ejection nozzle.

22. The apparatus for cleaning a web-like object to be cleaned according to claim 19, wherein
the wetting device is a device which is disposed near the gas ejection nozzle and ejects a humidifying gas to humidify the surface of the object to be cleaned.

23. The apparatus for cleaning a web-like object to be cleaned according to claim 10, wherein
the surface to be cleaned of the fed object to be cleaned is the lower surface of upper and lower surfaces of the object to be cleaned.
